(19) United States
(12) Patent Application Publication
(10) Pub. No.: US 2004/0210386 A1
(43) Pub. Date: Oct. 21, 2004

(54) System for communicating and associating information with a geographic location

(75) Inventors: Richard Todd Wood, Carmel, IN (US); Matthew Tyrone Armatis, Carmel, IN (US); David Michael Sutton, Carmel, IN (US); Jeffrey Allen Haskett, Carmel, IN (US)

Correspondence Address: Intellectual Property Group, Bose McKinney & Evans LLP, 2700 First Indiana Plaza, 135 North Pennsylvania Street, Indianapolis, IN, 46204, US

(73) Assignee: TerraGraphiX, Inc.

(21) Appl. No.: 10/840,609

(22) Filed: May 6, 2004

Related U.S. Application Data
(63) Continuation of application No. 10/189,869, filed on Jul. 3, 2002.

(51) Int. Cl. G01C 21/32

(52) U.S. Cl. 701/208; 340/995.1

(57) ABSTRACT

A system for associating information with a map feature including a computer having a display, a memory containing geographic data, and a user interface. Application software is provided for accessing user-selected geographic data to produce a map on the display. The software includes a selection tool for associating information with a selected map feature for later access by activating an indicium created in association with the feature. The system may be included in a dispatch system having mobile units in communication with a base unit for receiving a communication from a geographic location, and transmitting a message describing the location to a mobile unit. The mobile unit receives the message and executes the application software to generate a map on a display with an indicium representing the location, thereby providing visual directions to the location.

### CROSS-REFERENCE TO RELATED APPLICATION

This application is a continuation application of a pending U.S. patent application Ser. No. 10/189,869, filed Jul. 3, 2002, the disclosure of which is incorporated herein by reference.

### FIELD OF THE INVENTION

The present invention generally relates to mapping and communication systems, and more particularly to a system for associating information with a feature displayed on a digital map for use with a system for coordinating a response to an event at a geographic location.

### BACKGROUND OF THE INVENTION

Various systems and software exist for providing digital representations of geographic areas (i.e., maps) on, for example, a computer screen. Such conventional systems generally provide only generic information such as that available on paper maps (i.e., boundary indicators, roads, railroads, certain natural features, and some structures). The maps produced by conventional systems are deficient in that they fail to provide the user with the ability to associate user-provided information with specific locations on the maps.

Additionally, systems exist for communicating geographic location information to, for example, emergency response personnel, so that such personnel can respond to a reported event at the location. Typically, such conventional dispatch systems include simple radio communications between a dispatcher and a selected mobile unit or multiple mobile units. Upon making contact with the selected mobile unit, the dispatcher typically provides a verbal description of the location from which the communication reporting the event originated. The person in the mobile unit may refer to a conventional paper map to determine an acceptable route for reaching the location. The response time may be increased as a result of the verbal transfer of information, and the manual use of conventional paper maps.

### SUMMARY OF THE INVENTION

The present invention provides a system for associating information with a feature on a digital map including a computer having a display, a memory, and a user interface for receiving inputs from the computer user. A database of geographic data, stored in the memory of the computer, contains information for generating digital images of a plurality of geographic areas. Application software is provided for responding to the user input by causing the computer to access the geographic data to produce a digital map on the display corresponding to geographic data selected by the user. The software includes a selection tool that enables the user to select a feature on the map (e.g., a geographic location) and associate information, such as text, graphics, audio, and video, with the feature. The associated information is stored in memory, and is accessible by the user at a later time by activating an icon created by the software and displayed on the display in association with the selected feature.

The present invention further includes a dispatch system that incorporates the above-described system for associating information with a map feature. The dispatch system includes a plurality of mobile units and a base unit in communication with the mobile units. The base unit includes a receiver for receiving a communication originating from a geographic location, and a transmitter to selectively transmit a message including information describing the geographic location to a particular mobile unit. Each mobile unit includes a receiver configured to receive the message and a processor coupled to a display for displaying a map representing a geographic area including the geographic location. The processor of the mobile unit receiving the message responds by generating an indication on the map at a map location representing the geographic location, thereby providing visual directions to the geographic location without requiring a verbal description from a dispatcher or resort to conventional paper maps. The user of the mobile unit may also associate information with the geographic location (or any other map locations or features) as indicated above.

The features of the present invention described above, as well as additional features, will be readily apparent to those skilled in the art upon reference to the following description and the accompanying drawings.

### BRIEF DESCRIPTION OF THE DRAWINGS

FIG. 1 is a conceptual diagram of components of a system for associating information with a map feature according to the present invention.

FIG. 2 is a conceptual diagram of components of the software of the system of FIG. 1.

FIG. 3 is a screen shot depicting a map generated by the system of FIG. 1.

FIGS. 4-7 are screen shots depicting pull-down menus generated by the system of FIG. 1.

FIG. 8 is a screen shot depicting a zoom level feature of the system of FIG. 1.

FIGS. 9 and 10 are screen shots depicting an address search feature of the system of FIG. 1.

FIG. 11 is a screen shot depicting a longitude/latitude feature of the system of FIG. 1.

FIG. 12 is a screen shot depicting a layer control feature of the system of FIG. 1.

FIGS. 13 and 14 are screen shots depicting a distance measurement feature of the system of FIG. 1.

FIGS. 15-23 are screen shots depicting a process provided by the system of FIG. 1 for creating an indication in association with a map feature, and associating information with the feature.

FIG. 24 is a screen shot depicting a process for accessing information previously associated with a feature on a map generated by the system of FIG. 1.

FIG. 25 is a conceptual diagram of a dispatch system according to the present invention.

FIG. 26 is a conceptual diagram of a mobile unit of the dispatch system of FIG. 25.

FIGS. 27-52 are process diagrams and diagrams depicting forms, modules, and classes relating to the present invention including descriptions of properties, method definitions, parameters, and return types associated with the various form, module, and class diagrams.

### DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

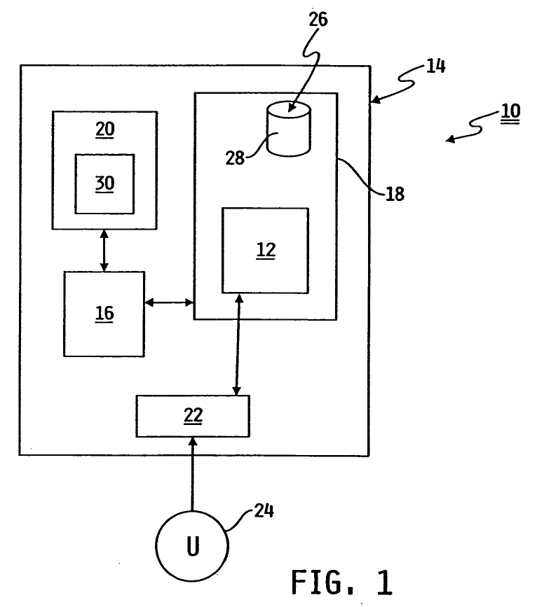

Referring now to FIG. 1, one embodiment of the present invention includes system 10 for associating information with a feature displayed on a digital map. System 10 includes application software 12 for execution on a computer 14 having a processor 16, a memory 18, a display 20, and a user interface 22. Computer 14 may be any of a variety of conventional computing devices having sufficient processing speed, memory capacity, display resolution, and other functional characteristics that are compatible with executing software 12. Additionally, user interface 22 may be any of a variety of conventional interface devices for use with computer 14 such as a mouse, keyboard, touch screen display, light pen, etc., or any combination thereof. User interface 22 is described herein as a combination of a keyboard and a mouse. As shown, computer 14 is operated by a user 24 via user interface 22.

Memory 18 stores application software 12 and a database 26 including geographic data 28. Geographic data 28 includes digital information stored in an organized manner based on geography with respect to a known reference location. More specifically, geographic data 28 may include a plurality of coordinates expressed, for example, as latitude and longitude designations representing actual locations on earth. Each set of coordinates has at least one and possibly many other data records associated with it. These other data records represent characteristics, such as map characteristics, associated with the actual location. For example, a particular set of coordinates may correspond to an actual location on earth having the characteristics that the location is in the state of Indiana, the county of Marion, and the city of Indianapolis. The location may further have the characteristics that it is in a park and on a road passing through the park. Data records representing all of these characteristics may be associated with the set of coordinates corresponding to the location.

As indicated above, geographic data 28 is organized in database 26 according to a geographical organization scheme. In one embodiment of the invention, geographic data 28 is organized as groups or collections of data describing certain geographic areas. For example, geographic data 28 may be grouped in database 26 in a hierarchical manner by country, state, county, city, etc. As further described below, geographic data 28 is accessed by processor 16 under control of software 12 to generate maps 30 depicting geographic areas on display 20.

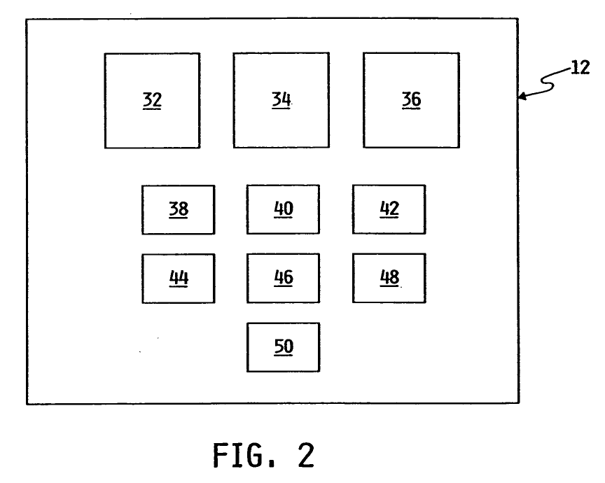

As shown in FIG. 2, application software 12 generally includes a map generation routine 32, an information retrieval routine 34, an interface routine (in embodiments that require application software 12 to communicate with other software such as in the dispatch system described below), a selection tool 38, a map control tool 40, a layer control tool 42, a copy map tool 44, a print map tool 46, a mode select tool 48, and a registration routine 50. In one embodiment, application software 12 is configured to run in a Windows environment. Of course, one of ordinary skill in the art could readily implement application software 12 in other operating systems or environments.

Registration routine 50 automatically executes a registration sequence upon installation of software 12 on computer 14, and prevents operation of software 12 until the registration sequence is complete. The registration sequence includes accessing information that identifies computer 14 and prompting user 24 to contact a provider of software 12 to report a code generated by software 12 based on that information. The provider may then provide user 24 with a registration code. Software 12 prompts user 24 to enter the registration code and thereafter functions as described below. In embodiments wherein software 12 is installed on multiple computers 14, the software provider is able to identify a particular user 24 using the registration code associated with user 24.

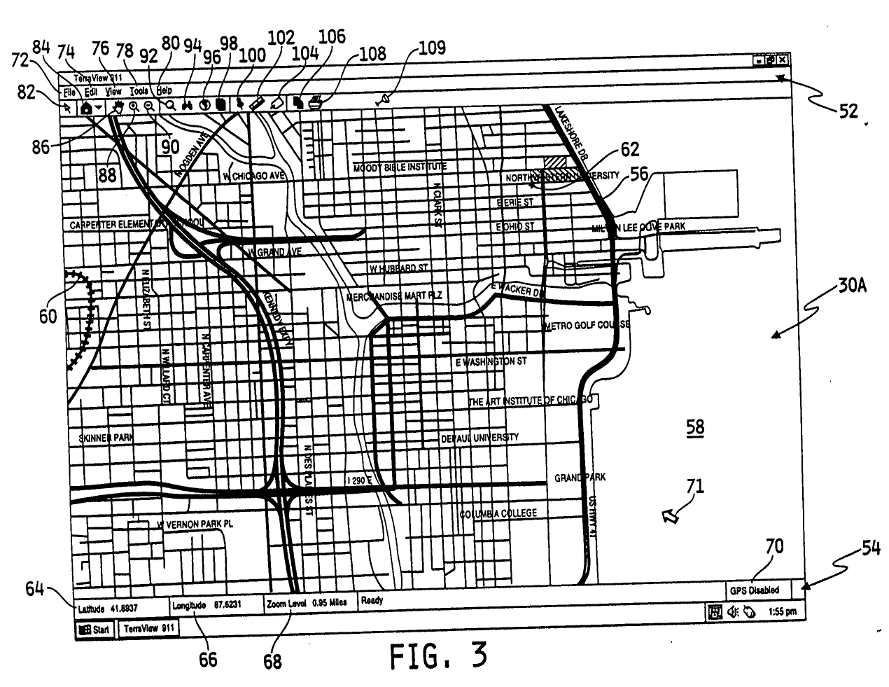

When software 12 is executed and initialized, map generation routine 32 causes processor 16 to access geographic data 28 stored in database 26 of memory 18. Software 12 is configured to provide a default map view upon start-up. Accordingly, processor 16 accesses geographic data 28 corresponding to the default map view and generates a map 30A as shown in FIG. 3 on display 20. Execution of software 12 also results in the generation of toolbar 52 and status bar 54. As shown, map 30A provides information representing a variety of different types of map features including roads 56, natural features such as bodies of water 58, railroads 60, and structures 62. Map 30A may also include actual aerial images of geographic areas, such as satellite photographs, etc. Also, map 30A may include any other image, regardless of its mode of generation or content, for overlay on Map 30A. When aerial images are displayed on map 30A, software 12 may also access portions of geographic data 28 corresponding to roads 56 or other map features and overlay those features onto the displayed aerial image. As will be further described below, the different types of information embodied in map 30A are grouped or arranged in map layers, each layer including information that shares a common map characteristic. For example, all structures 62 may be grouped into a single map layer. Accordingly, map 30A of FIG. 3 depicts a view of a plurality of simultaneously displayed map layers.

Status bar 54 includes a latitude status window 64, a longitude status window 66, a zoom level status window 68, and a GPS status window 70. As user 24 moves a cursor 71 to various locations on map 30A, the latitude and longitude designations displayed in latitude status window 64 and longitude status window 66 change to correspond to the latitude and longitude of the map location under cursor 71. Zoom level status window 68 displays the distance in miles corresponding to the horizontal dimension of map 30A. GPS status window 70 indicates whether system 10 is coupled to a GPS device (not shown) for receiving GPS data input. When a GPS device, such as an in-car GPS device configured to receive location data from a GPS satellite, is connected to computer 14, GPS status window 70 indicates that GPS is enabled. Software 12 then causes processor 16 to display the GPS location data on map 30A, thereby providing a real-time indication on map 30A of the present location of system 10. In mobile applications, this feature permits user 24 to view his or her location relative to a target location (such as the location of an emergency) and determine a route to the target location.

Tool bar 52 includes a file menu 72, an edit menu 74, a view menu 76, a tools menu 78, and a help menu 80. Tool bar 52 further includes a select item icon 82, a home icon 84, a pan icon 86, a zoom in icon 88, a zoom out icon 90, a set zoom level icon 92, an address search icon 94, a set lat/lon icon 96, a layer control icon 98, a selection icon 100, a measure distance icon 102, an auto-label icon 104, a copy map icon 106, a print map icon 108, and a GPS icon 109.

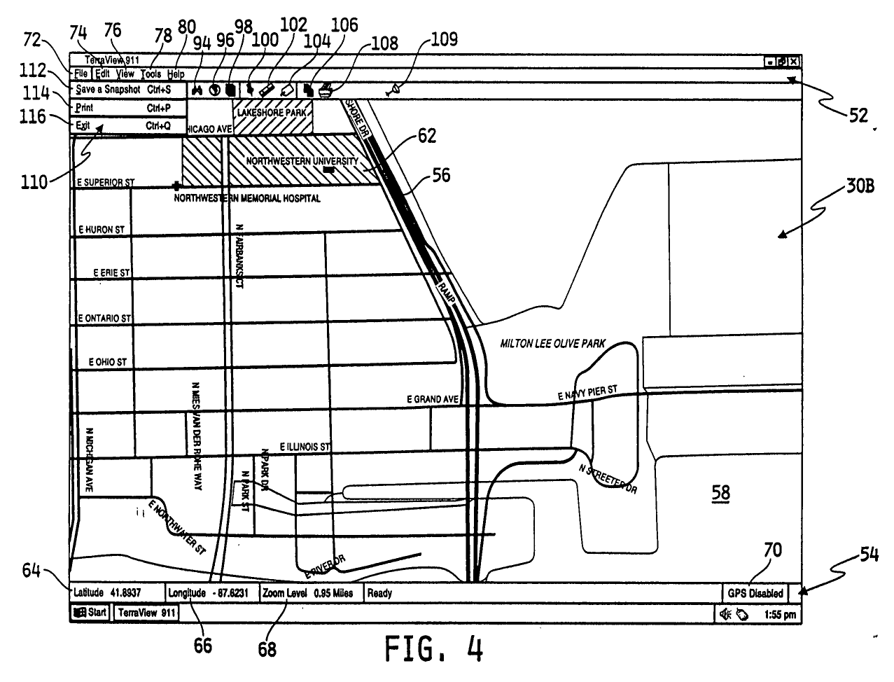

FIG. 4 shows a map 30B that corresponds to a zoomed-in portion of map 30A as indicated by zoom level window 68. As shown in FIG. 4, selection of file menu 72 generates a file pull-down menu 110 including a snapshot option 112, a print option 114, and an exit option 116. Selection of snapshot option 112 causes processor 16 to save the digital image of the geographic data 28 and any user-provided information corresponding to map 30B to a file in memory 18. It should be understood, however, that other types of export features may readily be incorporated consistent with the teachings of the present invention. For example, the presently displayed view of map 30B may be exported to a file, the presently displayed view along with data corresponding to any associated map layers (explained below) and/or user-defined information may be exported to a file. Additionally, the exported information may correspond to a screen view (as indicated above) or a user-selected area. For example, user 24 may define a box, circle, or other shape on display 20 using user interface 22 to select the area of map 30B to be exported. Alternatively, application software 12 may be configured to execute a query routine wherein user 24 is prompted to input a description of a map area selected for export (e.g., by providing the name of the desired county). In any event, the export file may be any of a variety of different formats such as bitmap, JPEG, TIF, etc. Print option 114 enables user 24 to print a copy of the currently displayed map 30B to a printer according to conventional printing procedures. Print map icon 108 executes the same print function as print option 114. Activation of exit option 116 terminates operation of software 12.

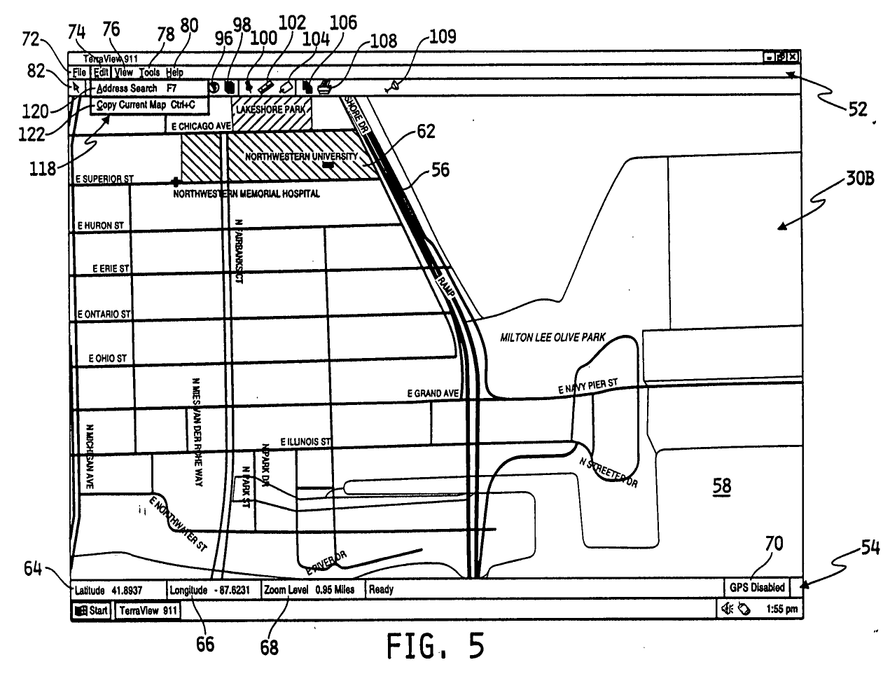

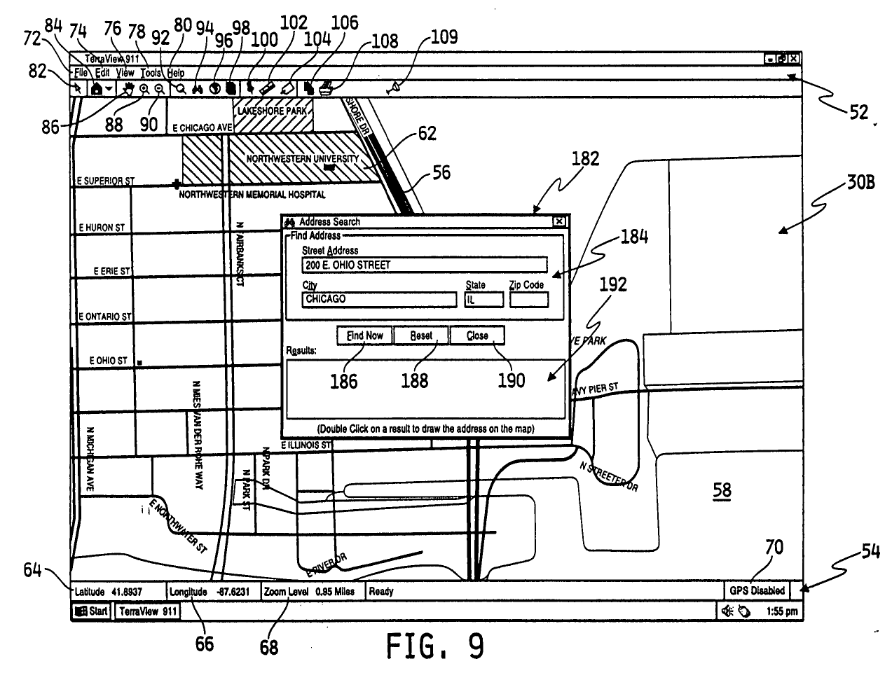

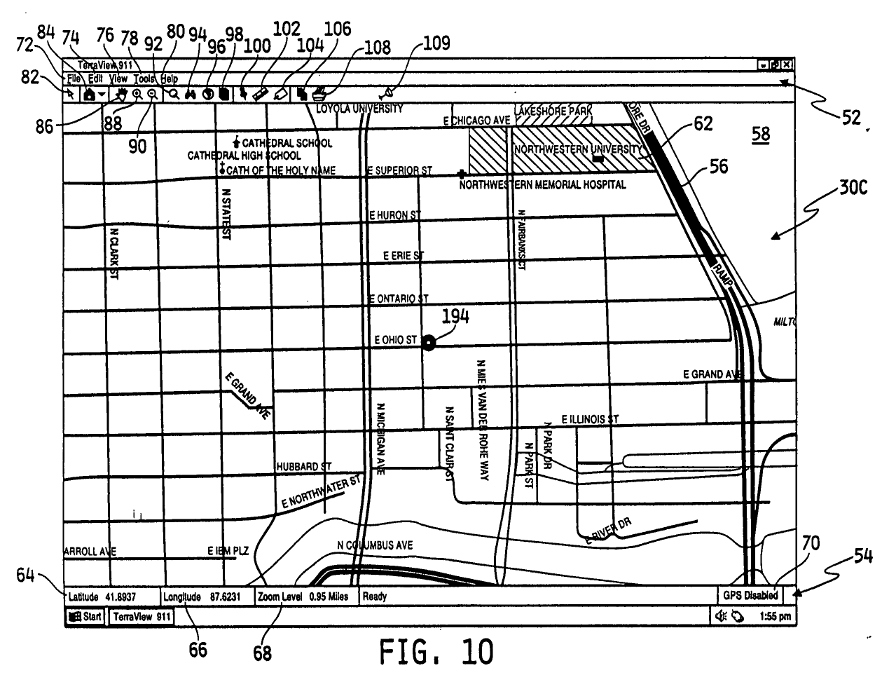

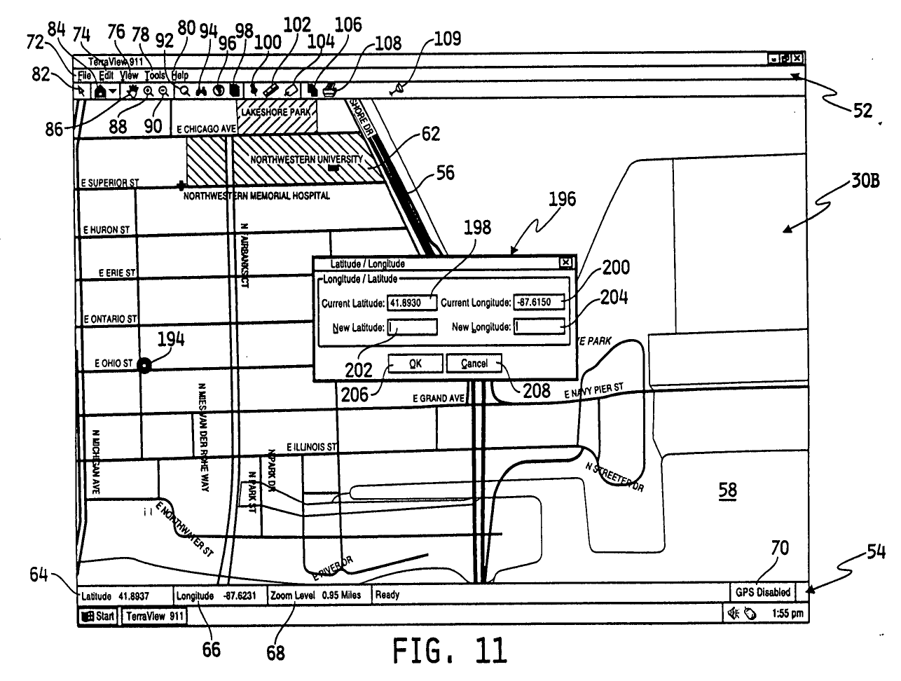

As shown in FIG. 5, selection of edit menu 74 generates an edit pull-down menu 118 including an address search option 120 and a copy map option 122. Selection of address search option 120 activates an address search routine as explained below with reference to FIGS. 9 and 10 and address search icon 94. Selection of copy map option 122 causes software 12 to generate a temporary copy of the currently displayed map 30B, and store the copy to a clipboard location (not shown) in memory 18 for later retrieval and manipulation. The function of copy map icon 106 is identical to copy map option 122.

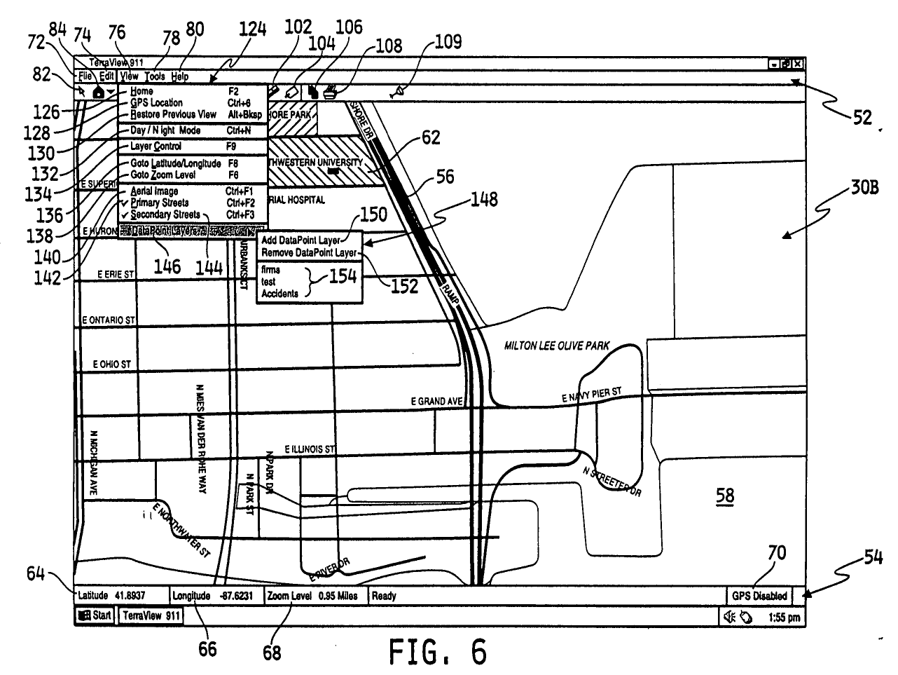

Referring now to FIG. 6, selection of view menu 76 generates a view pull-down menu 124 including a home option 126, a GPS location option 128, a restore previous view option 130, a mode option 132, a layer control option 134, a go to lat/lon option 136, a go to zoom level option 138, an aerial image option 140, a primary streets option 142, a secondary streets option 144, and a data point layers option 146. Selection of home option 126 causes software 12 to replace the currently displayed map 30B with the default map view, such as map 30A of FIG. 3. Selection of GPS location option 128 causes software 12 to generate a map view centered on the present location of system 10 as indicated by a GPS device connected to or in communication with computer 14. It should be understood that reference herein to the term “GPS” it intended to encompass not only conventional Global Positioning Systems, but also any type of local positioning system or other positioning system that derives a latitude and longitude location or relative position of a device on earth or elsewhere.

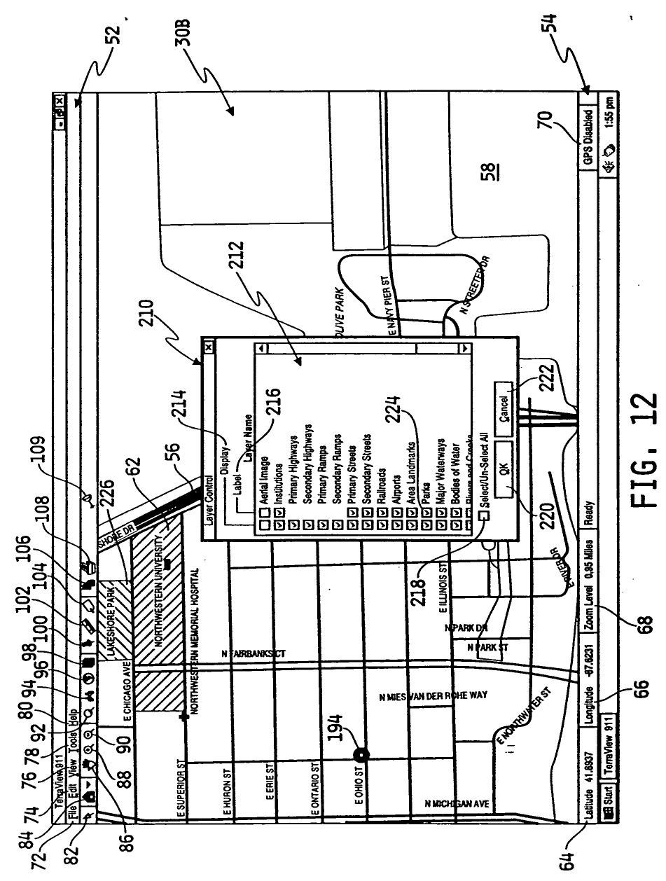

Activation of restore previous view option 130 causes software 12 to replace the currently displayed map 30B with the map view displayed prior to display of map 30B. As such, software 12 temporarily maintains in memory 18 a copy of the most recently replaced map views for retrieval upon activation of restore previous view option 130. Activation of mode option 132 toggles the display of map 30B between a day mode (as shown in FIG. 6) and a night mode (not shown). The night mode version of map 30B may include substantially the same information, but displays the information as an image having a reduced level of luminosity. For example, the background color of map 30B may be black or near black instead of gray or tan. The night mode may be desirable when user 24 wishes to minimize the amount of light generated by display 20 such as during a surveillance operation. Layer control option 134 permits user 24 to select the types of information or map features to be displayed on map 30B, as is further described below with reference to FIG. 12 and layer control icon 98. Similarly, go to lat/lon option 136 and go to zoom level option 138 function in the same way as is described below in the description of set lat/lon icon 96 and set zoom level icon 92, respectively. Activation of aerial image option 140 causes software 12 to display an actual aerial image of the presently displayed geographic area on map 30B. The aerial image may include high resolution detail of the topological features of the geographic area, including trees, alleys, homes, business facilities, and any other information not generally included in conventional roadmaps. Specifically, processor 16 accesses database 26 to obtain geographic data 28 corresponding to the aerial image. Processor 16 then generates the aerial image on display 20. In one embodiment of the invention, roads 56 are overlaid onto the aerial image. Primary streets option 142 permits user 24 to toggle between a map 30B displaying primary streets and their labels and a map 30B that does not display primary streets and their labels. Similarly, secondary streets option 144 permits user 24 to toggle between a map 30B with and without a display of secondary streets and their labels.

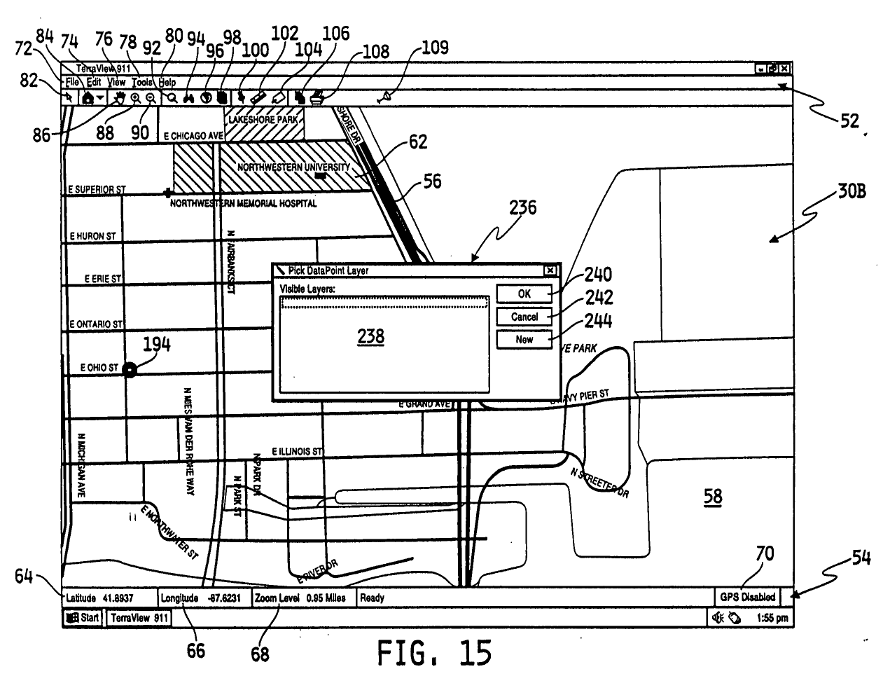

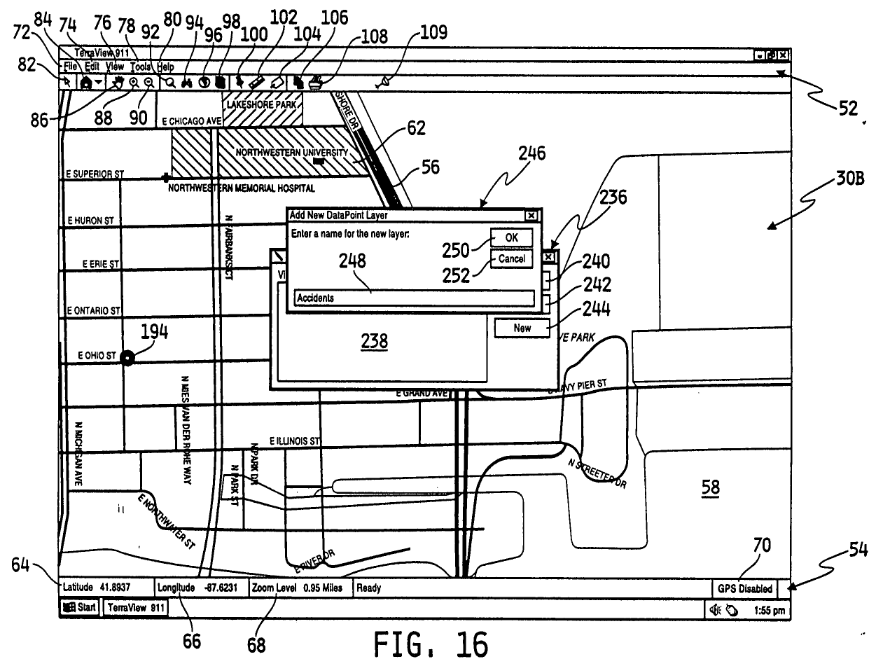

Finally, selection of data point layers option 146 causes software 12 to display data point layers sub menu 148. Data point layers sub menu 148 includes add data point layer option 150, remove data point layer option 152, and a listing of existing user-defined data point layers 154. It should be understood that use herein of the term “data point” in conjunction with any of the described features of the present invention is intended to encompass not only single points or zero area locations on map 30B, but also areas, groups of contiguous or non-contiguous points, layers of related map characteristics, and individual or multiple map features of any kind whatsoever. Add data point layer option 150 enables the user to create a data point layer by naming the data point layer and adding data points to the named layer as described in detail below with reference to FIGS. 15-23 and selection icon 100. Remove data point layer option 152 permits the user to delete a data point layer from the listing of user-defined data point layers 154.

It is within the scope of the present invention to provide an option for displaying data point layers 154 in a presentation sequence. Such an option may enable user 24 to provide instructions for displaying certain layers together, in alternation, or in some specific user-defined order.

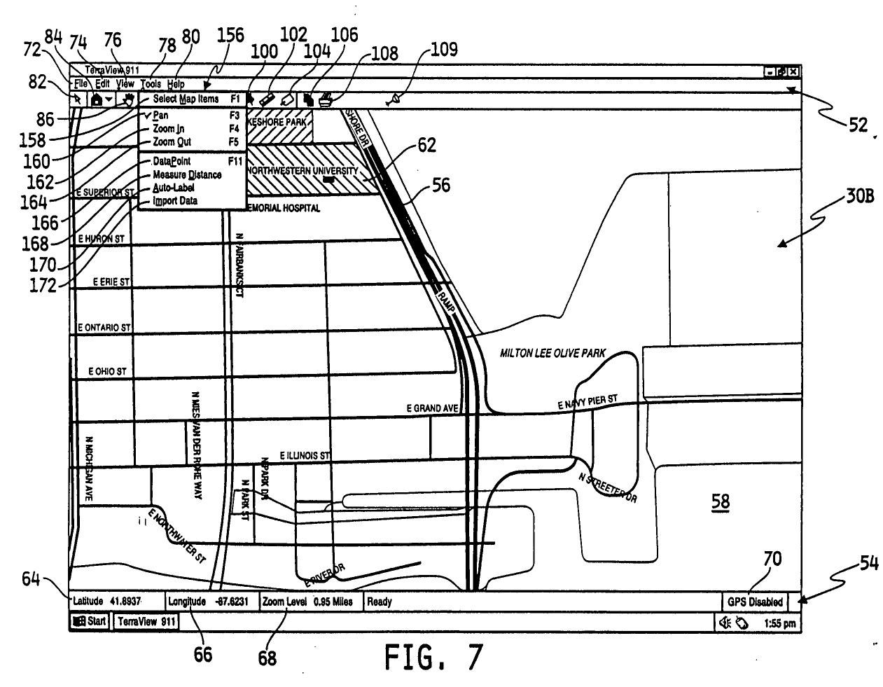

As shown in FIG. 7, selection of tools menu 78 generates a tools pull down menu 156 including a select map items option 158, a pan option 160, a zoom in option 162, a zoom out option 164, a data point option 166, a measure distance option 168, an auto label option 170, and an import data option 172. By activating select map items option 158, user 24 can click on individual map items such as data points, streets 56, structures 62, etc. When, for example, a data point is selected, user 24 may access any information previously associated with the data point. Also, after activating select map items icon 158, user 24 may, for example, hover a cursor of a pointing device over displayed items on map 30B, thereby causing software 12 to display any label information associated with the item that is not presently displayed on map 30B. Pan option 160, zoom in option 162, zoom out option 164, data point option 166, measure distance option 168, and auto label option 170 function in the same way as pan icon 86, zoom in icon 88, zoom out icon 90, selection icon 100, measure distance icon 102, and auto label icon 104, respectively. Each of these functions is described in detail below with reference to the above-mentioned corresponding icon. Import data option 172 permits user 24 to specify a data file, such as a spreadsheet, that includes properly formatted data for importation into database 26. For example, location information for data points, as well as any associated user-defined information, may be formatted in a spreadsheet file for processing by software 12. When the file is imported to database 26, software 12 may generate icons on map 30B at the defined data point locations and maintain any association of the data points to the user-defined information.

Selection of help menu 80 generates a conventional pull down menu that permits user 24 to access a table of contents, an index, and descriptive information relating to software 12 and the features described herein.

Referring still to FIG. 7, select item icon 82 functions in the same manner as select map items option 158 described above. As also described above with reference to home option 126, selection of home icon 84 causes software 12 to replace the current map 30B with the default map view generated upon execution of software 12.

When user 24 activates pan icon 86, software 12 reconfigures cursor 71 (FIG. 3) and enables user 24 to click on a location of map 30B, move cursor 71 in a direction relative to that location, and release the mouse button. Of course, software 12 could readily be configured to permit any conventional method of defining a first location and a second location via user interface 22, such as clicking and releasing on two locations, clicking and holding at a first location and releasing on a second location, etc. A geographically shifted version of map 30B is then generated as processor 16 accesses database 26 to obtain geographic data 28 necessary to create new portions of map 30B. Specifically, the distance between the first selected location and the panned to location provides software 12 with instructions to shift or move map 30B the selected distance and direction. For example, if user 24 selects a location on map 30B and moves cursor 71 downwardly a distance corresponding to one mile, then software 12 regenerates a version of map 30B that excludes the previously displayed lower one mile portion of map 30B and includes a newly displayed upper one mile portion by accessing the appropriate geographic data 28 in database 26.

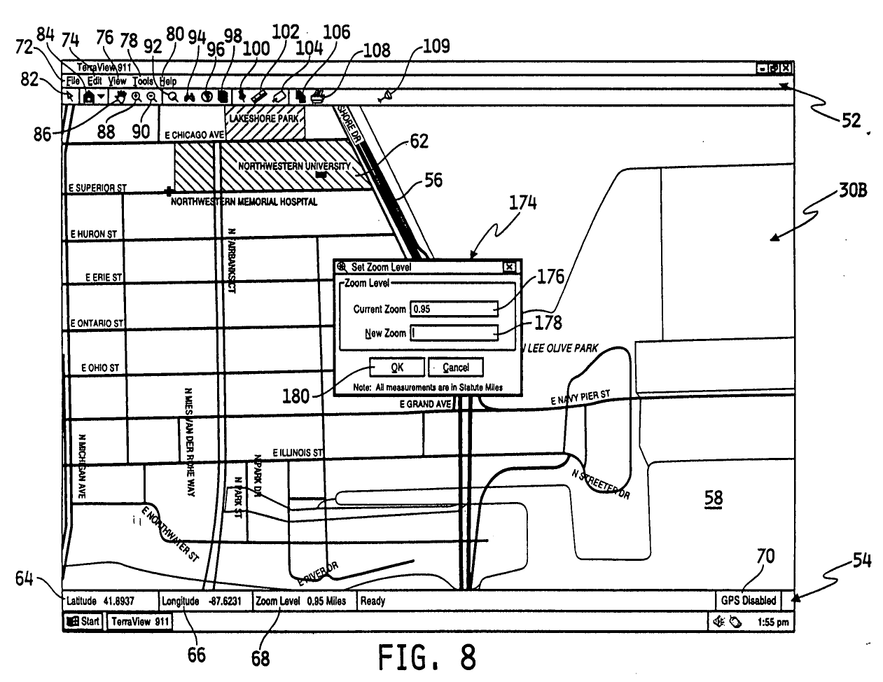

Referring now to FIG. 8, activation of zoom in icon 88 permits user 24 to click on a location of map 30B and obtain a zoomed in view of that location. For example, software 12 may automatically double the zoom level each time user 24 clicks on a map location. Additionally, software 12 may center the newly generated, zoomed in map 30B on the location selected for zoom by user 24. It should be understood that various map features, details or data layers may be displayed only at certain zoom levels. The function of zoom out icon 90 is similar to that of zoom in icon 88, except that the map zoom level is decreased by some predetermined amount (e.g., ½ the previously selected zoom level).

When user 24 selects set zoom level icon 92, software 12 generates a set zoom level dialogue box 174 as shown in FIG. 8. Set zoom level dialogue box 174 displays the current zoom level in field 176 (also displayed in zoom level status window 68 of status bar 54) and permits user 24 to enter a desired zoom level in new zoom level field 178. When user 24 then activates OK button 180, software 12 causes processor 16 to access the appropriate geographical data 28 in database 26 to generate a new version of map 30B corresponding to the selected zoom level.

FIGS. 9 and 10 depict a procedure for finding a specific address location on map 30B. As shown in FIG. 9, by selecting address search icon 94, user 24 causes software 12 to generate an address search dialogue box 182. Address search dialogue box 182 includes a find address portion 184, a find now button 186, a reset button 188, a close button 190, and a results field 192. Using user interface 22, user 24 may input an address including street address, city, state, and zip code into find address portion 184. By activating reset button 188, user 24 may delete previously entered data in find address portion 184. User 24 may terminate the address search function by activating close button 190. If user 24 desires to locate the entered address, then user 24 activates find now icon 186. Processor 16 then searches geographic data 28 in database 26 to locate geographic data 28 corresponding to the entered address. As indicated above, geographic data 28 is stored in database 26 in collections of data corresponding to specific geographic areas, such as counties. Memory 18 of computer 14 also includes data (not shown) that may be configured by user 24 to define a predetermined search sequence of geographic areas. For example, if user 24 simply inputs a street address (without a city and state), then software 12 may, according to this predetermined sequence, search the default county for the specific address before searching a second county, a third county, etc. for geographic data 28 corresponding to inputted street address. If multiple matches are found, the results of the above-described search operation are displayed in results field 192. Additionally, results field may display a closest match to the user-provided address information when the specific address is not found. The desired address result may be selected by user 24 using user interface 22. When a desired address result is selected, or only a single address result is found, software 12 causes processor 16 to access geographic data 28 corresponding to a geographic area centered on the desired address result. This geographic data 28 is then used to generate a new map 30C on display 20 as depicted in FIG. 10. As shown, software 12 also generates an icon 194 centered on the map location corresponding to the desired address result.

Referring now to FIG. 11, selection of set lat/lon icon 96 causes software 12 to generate a latitude/longitude dialogue box 196 including current latitude field 198, current longitude field 200, new latitude field 202, and new longitude field 204. The current latitude and longitude designations are displayed in current latitude field 198 and current longitude field 200, respectively. User 24 may, using user interface 22, input new latitude and longitude designations in new latitude field 202, and new longitude field 204, respectively. By activating OK button 206, user 24 causes processor 16 to access geographic data 28 corresponding to a geographic area at the present zoom level centered on the longitude and latitude designations entered by user 24. This new map (not shown) is then displayed on display 20. Of course, user 24 may terminate the set latitude/longitude operation using cancel button 208.

As shown in FIG. 12, by activating layer control icon 98, user 24 causes software 12 to generate layer control dialogue box 210. Layer control dialogue box 210 generally includes a layer name area 212 that lists a plurality of different map layers, each sharing a common map characteristic. Each listed layer has associated with it a check box arranged in a display column 214 and a check box organized under a label column 216, unless configured otherwise. Layer control dialogue box 210 also includes a select/unselect all check box 218, an OK button 220, and a cancel button 222. User 24 may, via user interface 22, select or deselect any of the check boxes arranged under display column 214 and label column 216. In this manner, user 24 may customize the view of map 30B by including only selected information from the selected layers. By deselecting check boxes under the label column 216, but selecting the corresponding check box under display column 214, user 24 may cause software 12 to display a certain map characteristic contained in the specific layer, but not display the label corresponding to that characteristic. For example, by deselecting check box 224 of the parks layer and activating OK button 220, user 24 causes map 30B to be regenerated, but area 226 corresponding to Lake Shore Park is displayed without the label “Lake Shore Park.” Cancel button 222 permits user 24 to terminate the manipulation of various map layers as described above. Select/unselect all check box 218 provides user 24 with a convenient way to populate all check boxes in columns 214, 216 when user 24 desires to deselect only a few boxes, or depopulate all of the check boxes in columns 214, 216 when user 24 desires to select only a few boxes.

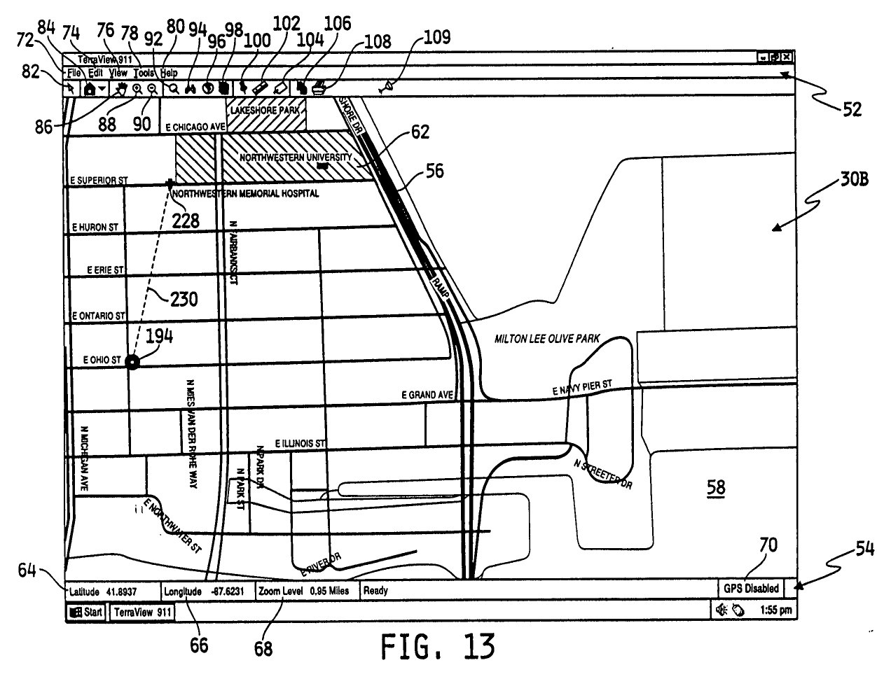

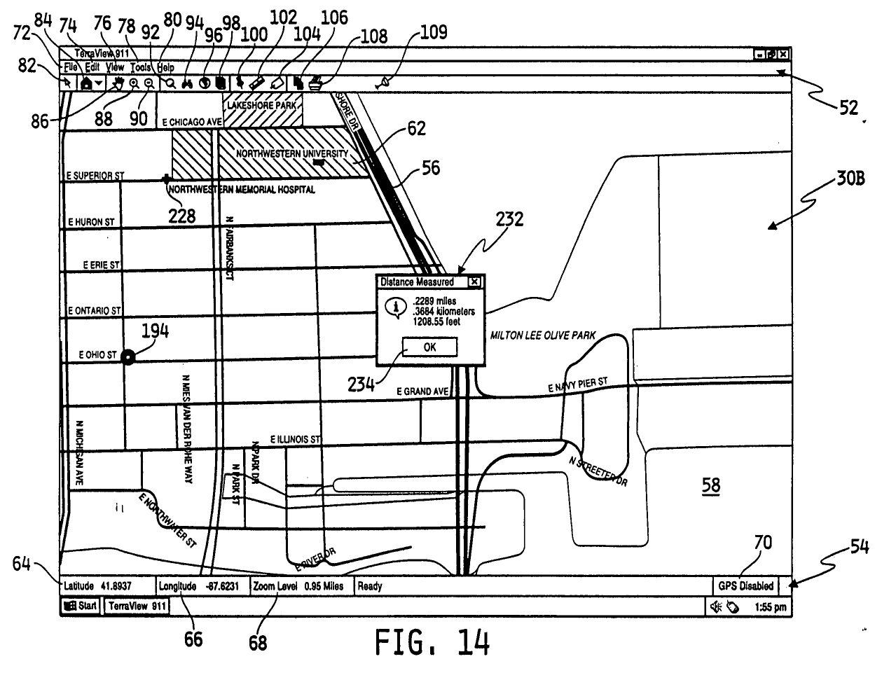

Referring now to FIGS. 13 and 14, when user 24 activates measure distance icon 102, software 12 reconfigures cursor 71 (not shown) into a cross hair symbol. User 24 may then click on a selected location on map 30B (e.g., symbol 194 of the address selected during the find address procedure described above), move to a second location (such as Northwestern Memorial Hospital 228), and release the mouse button. As user 24 moves cursor 71 (not shown) from the first selected position 194 to the second selected position 228, software 12 generates a dotted line 230 indicating the distance on map 30B to be measured. Again, any conventional procedure using user interface 22 for selecting two locations may be used. When user 24 releases the mouse button, software 12 generates a distance measured information box 232 as shown in FIG. 14. Distance measured information box 232 includes the result of the measured distance in miles, kilometers, and feet. User 24 may activate the OK button 234 to remove distance measured information box 232.

FIGS. 15-23 depict the process for creating a data point layer and populating the created layer with data indicia. The following example of creating a data point layer and a data indicium in that layer assumes that user 24 desires to associate information with a single location on map 30B (i.e., the found address corresponding to symbol 194 shown in FIG. 15). It should be understood, however, that user 24 may create a data indicium at any location on map 30B or at multiple locations. Additionally, as explained above, user 24 may select any feature or set of features on map 30B, generate a data indicium for the selected feature(s), and associate information with the selected feature(s) according to the principles of the present invention. User 24 begins the process of creating a data point layer including the location designated by symbol 194 by activating select icon 82 and clicking on symbol 194. After user 24 selects symbol 194, user 24 may, for example, right click on symbol 194 to display an option for creating or deleting a data indicium (not shown).

By selecting the make data indicium option (not shown), user 24 causes software 12 to generate a pick data point layer dialogue box 236 as shown in FIG. 15. Pick data point layer dialogue box 236 includes a visible layers field 238, an OK button 240, a cancel button 242, and a new button 244. All of the presently displayed data point layers corresponding to map 30B are listed in visible layers fields 238. In this example, no user-defined layers are visible. If layers were listed in visible layers field 238, user 24 could select a desired layer and click OK button 240. Of course, user 24 may terminate the data point layer creation procedure by activating cancel button 242. In the circumstance shown, user 24 would activate new button 244 to indicate the desire to create a new data point layer including the selected location (i.e., symbol 194).

Upon activating new button 244, user 24 causes software 12 to generate an add new data point layer dialogue box 246 as shown in FIG. 16. Add new data point layer dialogue box 246 includes a name field 248, an OK button 250, and a cancel button 252. User 24 enters a name for the new data point layer via user interface 22 in name field 248. Again, user 24 may cancel this operation by activating cancel button 252. Upon activating OK button 250, user 24 begins the procedure for defining a new data indicium to be associated with the newly named data point layer.

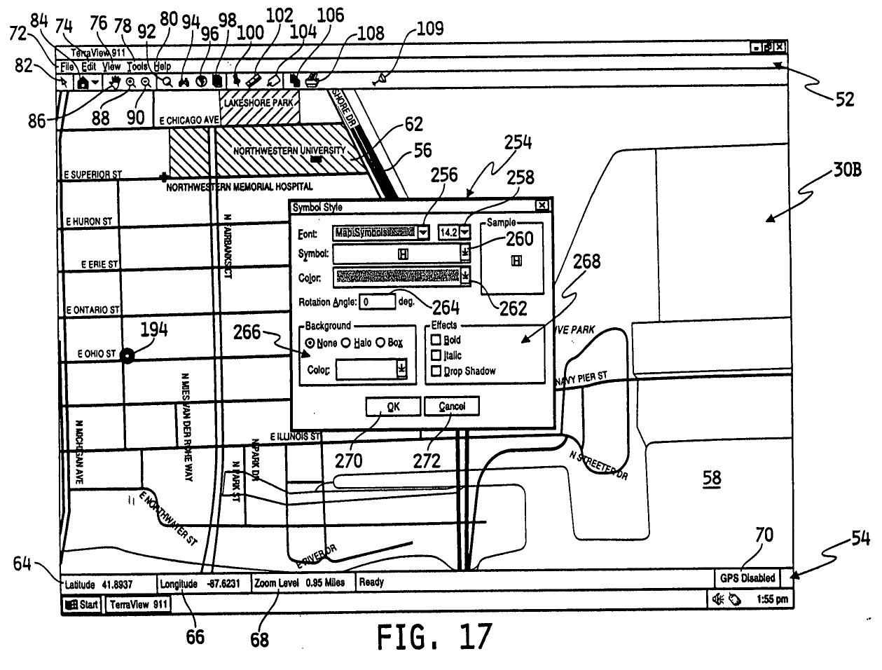

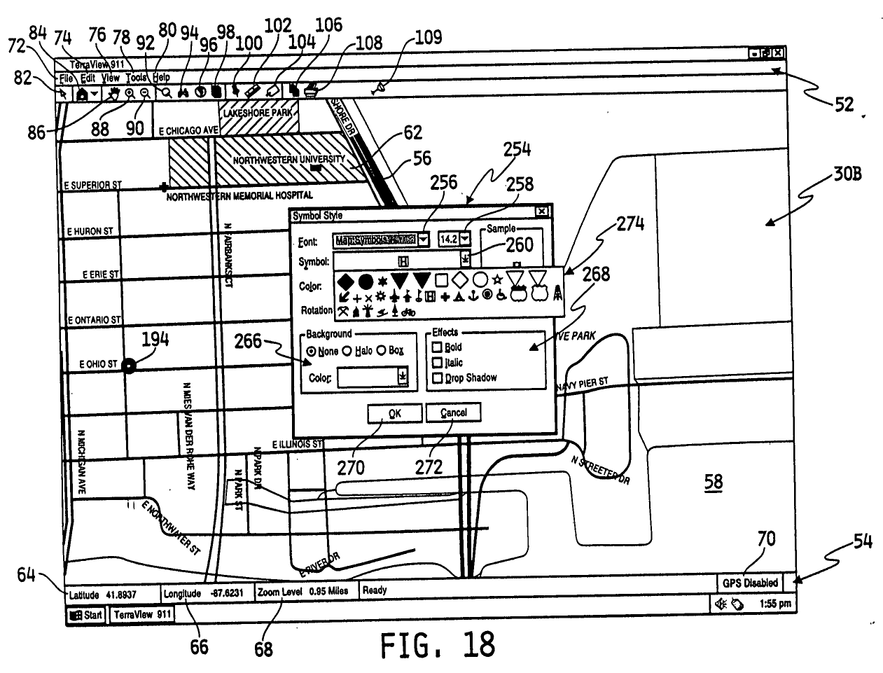

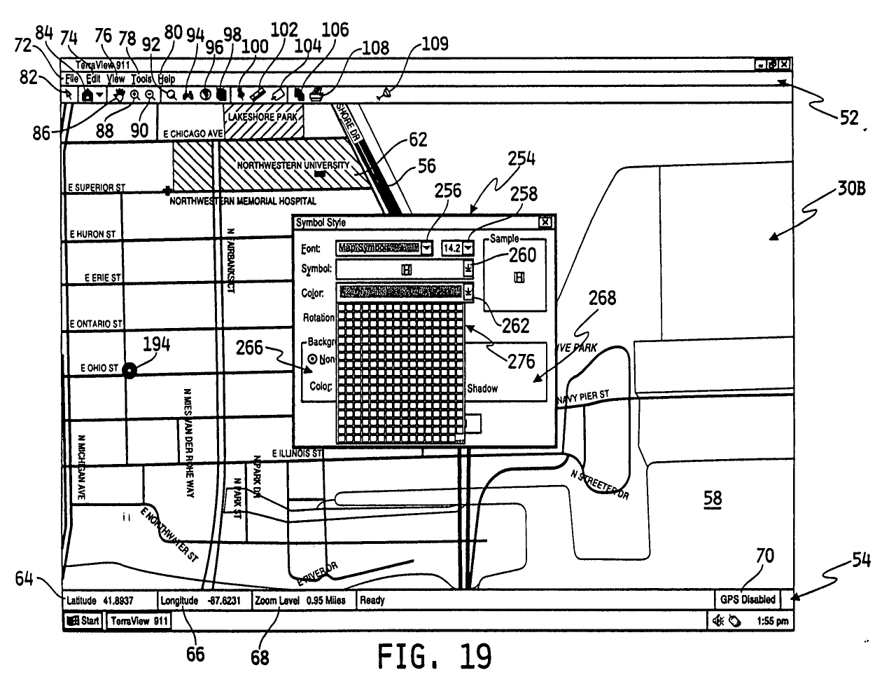

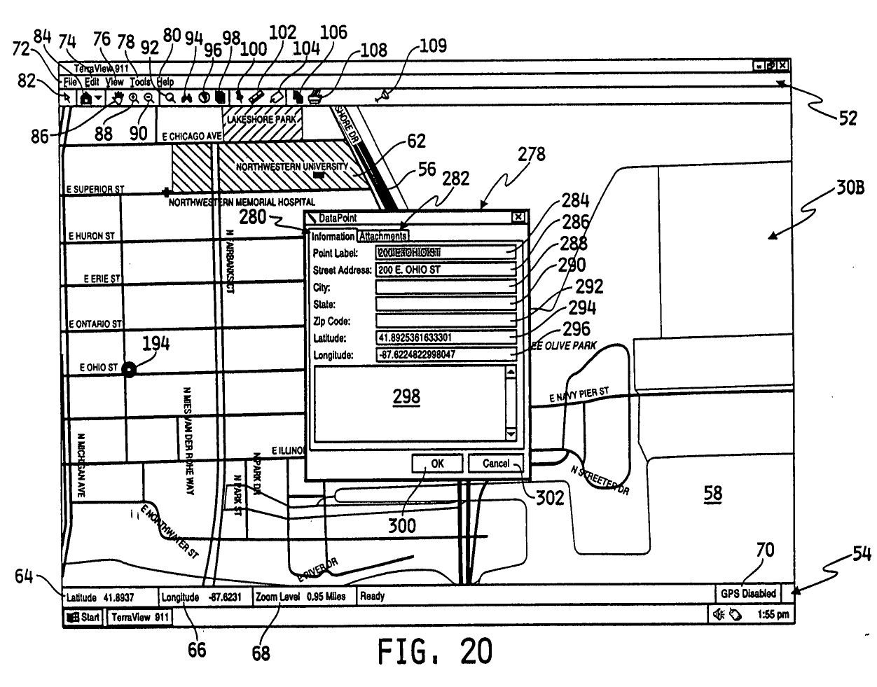

Referring now to FIG. 17, after naming the data point layer as described above, and clicking OK button 250 of add new data point layer dialogue box 246, user 24 causes software 12 to generate a symbol style dialogue box 254 to enable user 24 to specify a particular symbol corresponding to the new data indicium. Symbol style dialogue box 254 generally includes a font pull down menu button 256, a font size pull down menu button 258, a symbol pull down menu button 260, a color pull down menu button 262, a rotation angle field 264, a background area 266, an effects area 268, an OK button 270, and a cancel button 272. By activating font style pull down button 256, user 24 causes software 12 to present a pull down menu of various font styles, each containing a plurality of different symbols (not shown). Font size pull down menu button 258 enables user 24 to select from a variety of different predetermined font sizes or to enter a desired font size. Upon activating symbol pull down menu button 260, user 24 causes software 12 to generate a display 274 of all of the available symbols corresponding to the currently selected symbol font as shown in FIG. 18. User 24 then selects from the symbols included in display 274. Upon selection of color pull down menu button 262, software 12 similarly presents user 24 with a color pallet 276 as shown in FIG. 19 from which user 24 may select the color of the previously selected symbol for use as the data indicator. Rotation field 264, background area 266, and effects 268 further permit user 24 to customize the appearance of the data indicium.

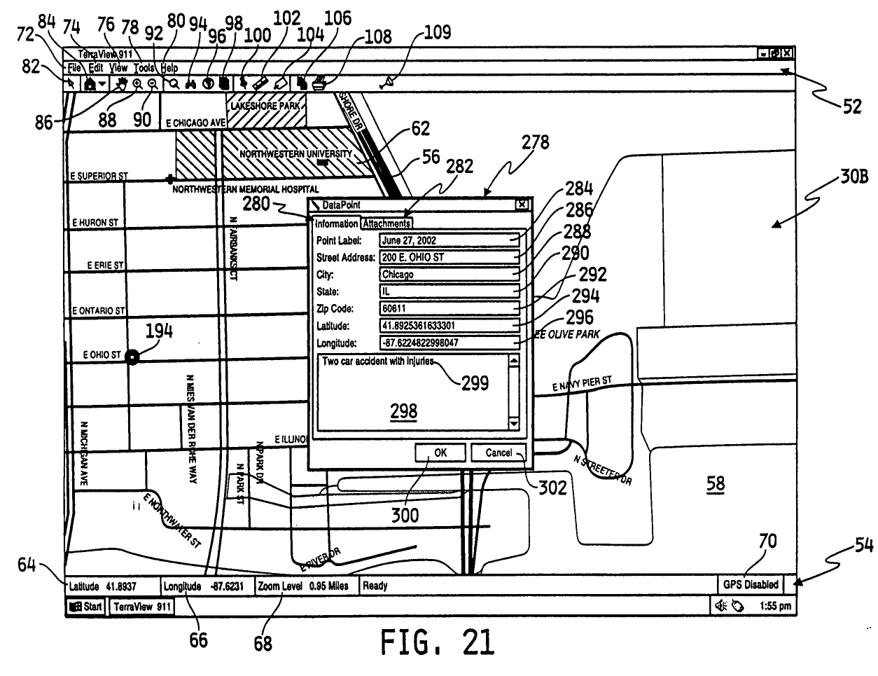

Upon activation of OK button 270 user 24 causes software 12 to generate dialogue box 278 as shown in FIG. 20. Dialogue box 278 generally includes an information tab 280, an attachments tab 282, an OK button 300 and a cancel button 302. FIG. 20 depicts dialogue box 278 with information tab 280 selected. Information tab 280 includes a label field 284, a street address field 286, a city field 288, a state field 290, a zip code field 292, a latitude field 294, a longitude field 296, and a notes field 298. In this particular example, label field 284 defaults to the street address provided by user 24 during the address search routine described above for locating the address indicated by symbol 194. As shown in FIG. 21, user 24 may, via user interface 22, rename the data indicium (for example, by giving the data indicium a date name such as “Jun. 27, 2002”), and fill in the remaining address information and fields 286-292. Latitude field 294 and longitude field 296 are automatically populated by software 12 with the latitude and longitude designations corresponding to the location selected for creation of a data indicium. As also shown in FIG. 21, user 24 may input user-defined notes 299 in notes field 298, thereby associating user-defined notes with, for example, a particular geographic location on map 30B corresponding to the newly created data indicium. Additionally, user 24 may associate files of information with the data indicium by activating attachments tab 282.

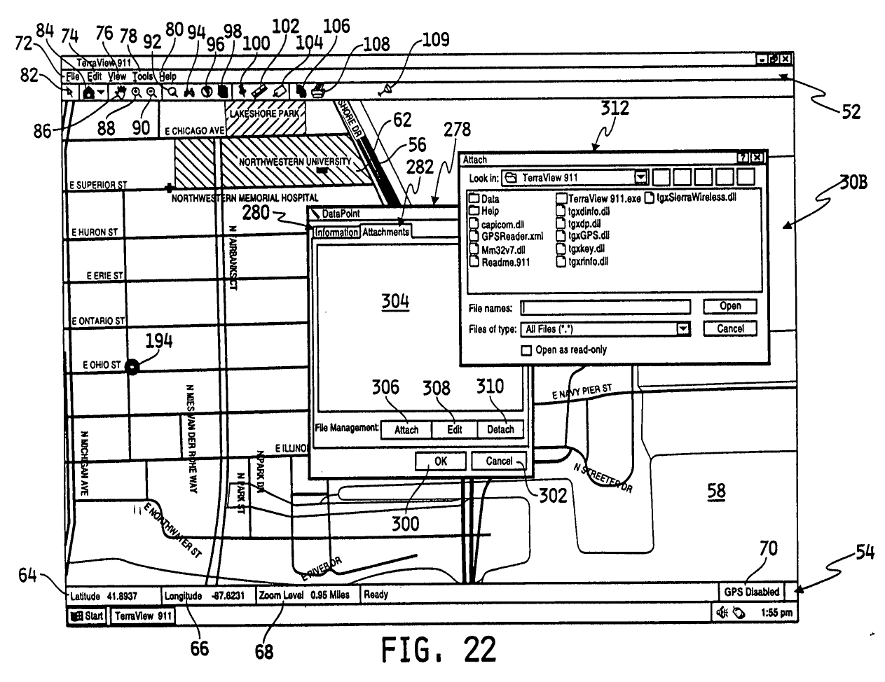

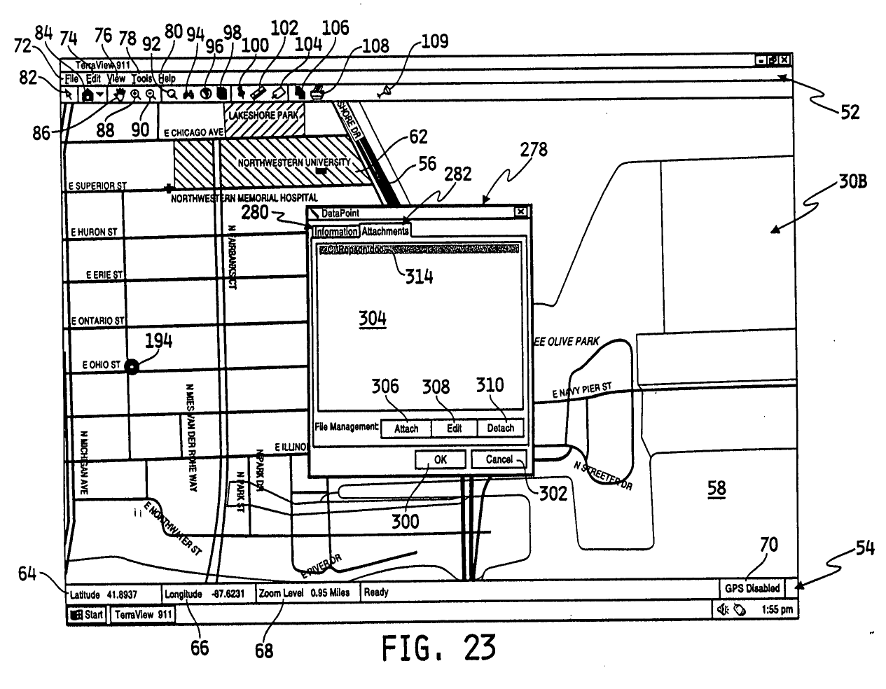

Referring now to FIG. 22, activation of attachment tab 282 causes software 12 to replace information tab 280 in dialogue box 278 with attachments tab 282 which includes an attachments field 304, an attach button 306, an edit button 308, and a detach button 310. Attachments field 304 provides a list of all attachments associated with the present data indicium. In this example, user 24 is creating a new data indicium and attachments field 304 is blank. Accordingly, edit button 308 and detach button 310 are inoperable. By activating attach button 306, user 24 causes software 12 to generate attach dialogue box 312. Attach dialogue box 312 includes a plurality of conventional file management fields and tools for searching the contents of memory 18 to select preexisting files for association with the present data indicium. It should be understood that such files may include any type of information that may be stored in a computer readable media. For example, files for attachment in association with the data indicium may include text files, graphics files, audio files, video files, and any combination thereof. As an example of a graphics file, user 24 may associate a file including a floor plan or other diagram with a data indicium created in association with a particular structure on map 30B such as a school. In addition to selecting preexisting files, user 24 may right click on dialogue box 312 to initiate a process wherein a software application (such as a word processor or spreadsheet application) is executed to permit user 24 to create a new file for association with the data indicium. Once user 24 has selected (or created) the desired attachment, attachment dialogue box 312 is removed and the attachment 314 is listed in attachments field 304 as shown in FIG. 23.

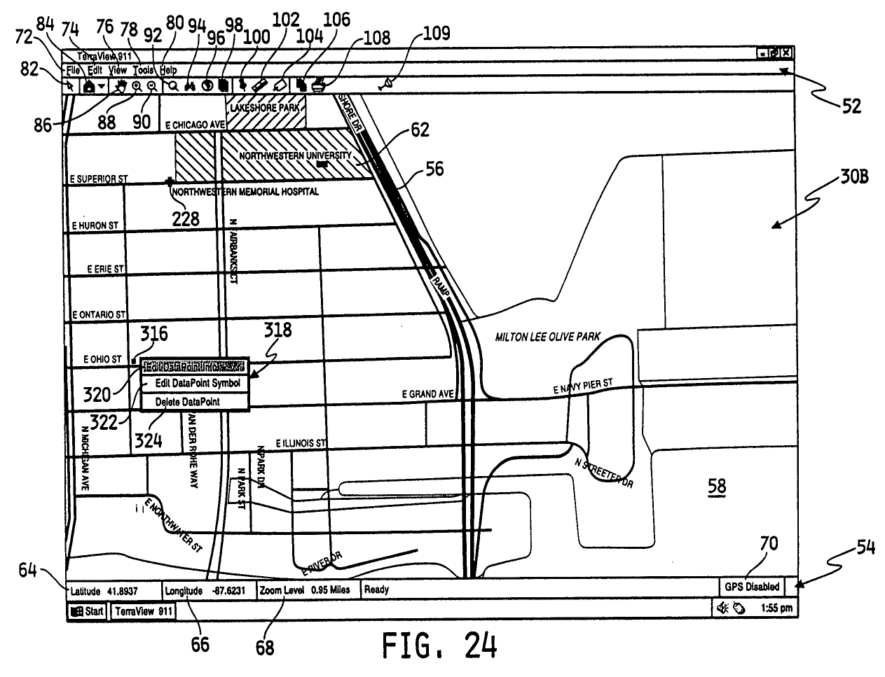

When user 24 activates OK button 300 of dialogue box 278, software 12 generates the data indicium 316 (FIG. 24) as defined by user 24 using the above-described procedure. Thereafter, user 24 may access the information associated with data indicium 316 by activating select item icon 82 and clicking on data indicium 316. Once data indicium 316 is selected, user 24 then right clicks to cause software 12 to generate box 318. Box 318 includes an edit info option 320, an edit symbol option 322, and a delete option 324. When user 24 selects edit info option 320, software 12 presents user 24 with dialogue box 278 as shown in FIG. 21. In this manner, user 24 may review user-defined notes 299, and the other information associated with data indicium 316 and presented in information tab 280. When user 24 selects edit symbol 322, software 12 presents user 24 with symbol style dialogue box 254 as shown in FIG. 17. User 24 may then select from the various functions provided by symbol style dialogue box 254 to modify the appearance of data indicium 316. Delete option 324 removes data indicium 316 from memory 18.

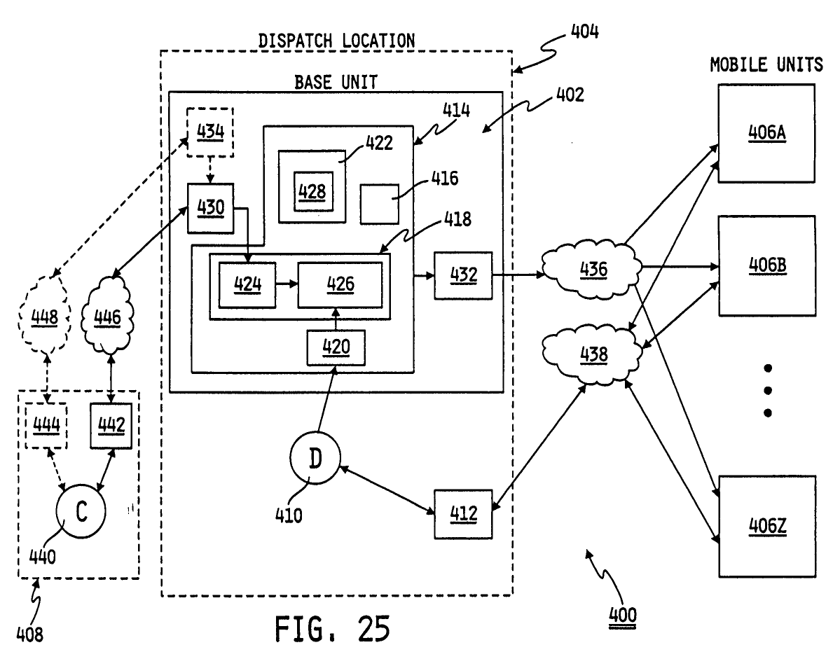

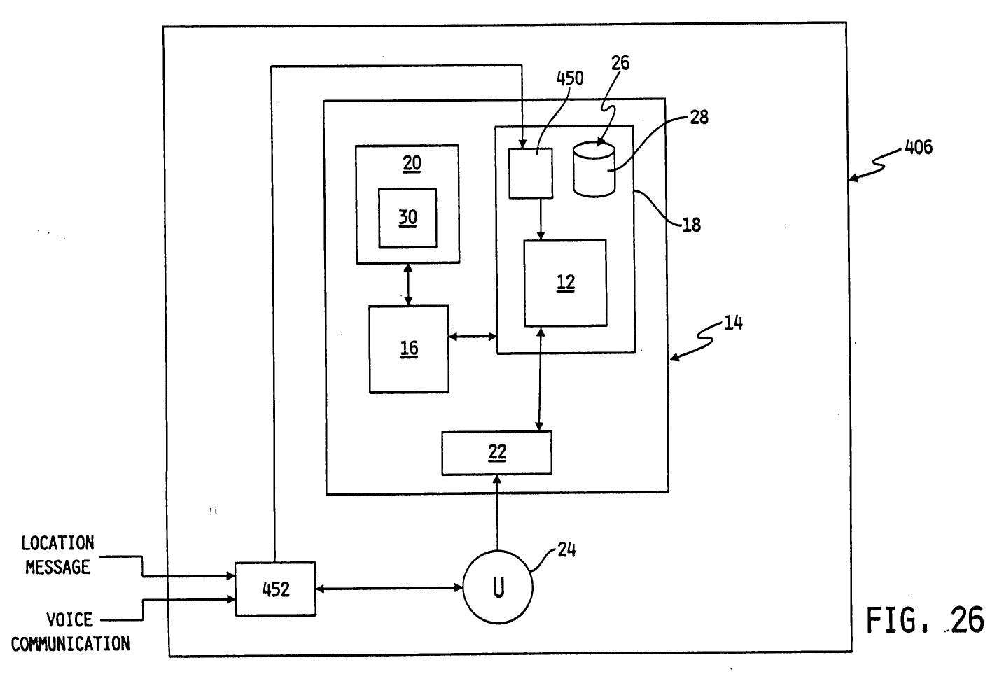

Referring now to FIG. 25, one application of system 10 of the present invention is shown in a system for coordinating a response to an event at a geographic location. System 400 generally includes a base unit 402 at a dispatch location 404 that is in communication with a plurality of mobile units 406A-Z and a caller location 408. In addition to base unit 402, dispatch location 404 is shown as including a dispatcher 410 and a communication device 412. Base unit 402 includes a computer 414 having a microprocessor 416, a memory 418, a user interface 420, and a display 422. Memory 418 includes interface software 424 and dispatch software 426. Display 422 is configured to display a map 428 similar to maps 30 described above. Base unit 402 further includes a receiver 430, a transmitter 432, and a GPS interface 434 shown in dotted lines to indicate that GPS interface 434 may not be included in certain embodiments.

Mobile units 406A-Z may be vehicles such as emergency response vehicles or police vehicles, or other types of mobile units such as individuals, airplanes, ships, or any other moveable entity. As will be further described below, mobile units 406A-Z are connected to transmitter 432 of base unit 402 via network 436. Mobile units 406A-Z are also connected to communication device 412 at dispatch location 404 by network 438.

Caller location 408 includes a caller 440, a telephone 442, and a GPS device 444. It should be understood that GPS device 444 may be incorporated into a cellular telephone or constitute any other type of GPS device. Telephone 442 is connected to receiver 430 via a conventional telephone network 446. It should be understood that telephone 442 may be a cellular telephone, and network 446 may be a cellular communication network. GPS device 444 is connected to GPS interface 434 at base unit 402 via wireless network 448.

FIG. 26 depicts a mobile unit 406. Mobile unit 406 includes a computer that is substantially the same as computer 14 of system 10 depicted in FIG. 1. Accordingly, the same reference designations will be used for similar components in FIG. 26. Computer 14 includes software 12, a processor 16, a memory 18, a display 20, a user interface 22, and a database 26 of geographic data 28 stored in memory 18. Memory 18 of computer 14 further includes location interface software 450. Mobile unit 406 also includes a communication device 452. Computer 14 and communication device 452 are operated by user 24.

The following example of the operation of system 400 assumes use of the system to facilitate communication and coordination between a police dispatcher (represented by dispatcher 410) and a plurality of police cars (represented by mobile units 406A-Z). It should understood, however, that any of a variety of different applications are possible, consistent with the teachings of the present invention.

According to one embodiment of the invention, a caller 440 wishing to report an event at caller location 408 (such as a police emergency) uses telephone 442 to place a telephone call via network 446 to dispatch location 404. Receiver 430 of base unit 402 receives the telephone call or communication that, according to well-known principles in the art, may include encoded information describing the address of caller location 408. Receiver 430 provides this information to interface software 442 that, according to principles well-known in the art, processes the information into address data that is provided to dispatch software 426. It should understood that the communication from caller 440 may also be processed by dispatcher 10 and manually inputted into computer 14 via user interface 420. Alternatively, caller 440 may transmit the communication to dispatch location 404 using GPS device 444 over wireless network 448. Such communication is received by GPS interface 434 and includes GPS location information which may be converted through receiver 430 and interface software 422 into address location information for use by dispatch software 426. As a further alternative, GPS location coordinates may be provided directly to dispatch software 426 for communication to mobile units 406A-Z in a GPS format, assuming mobile units 406A-Z are equipped with an enabled GPS feature as described above. GPS interface 434 includes software that is configurable (using conventional techniques) to communicate with a plurality of GPS devices 444 having different communications protocols.

After base unit 402 receives the communication from caller 440, dispatch software 426 causes processor 416 to generate map 428 on display 422. Map 428 is similar to maps 30 depicted in FIGS. 3-24 and described with reference thereto. The address information derived from the communication is used by dispatch software 426 (invoking an address search routine similar to that described above) to generate an icon (not shown) on map 428. Map 428 may also include icons depicting the location of the plurality of mobile units 408A-Z. Accordingly, dispatcher 410 can determine from the relative locations of caller location 408 and the locations corresponding to mobile units 406A-Z, which of mobile units 406A-Z is closest to caller location 408. Of course, depending upon the nature of the call, dispatcher 410 may not dispatch the call to the closest mobile unit 406A-Z. In any event, dispatcher 410 determines which of mobile units 406A-Z is most appropriate for response to the event reported at caller location 408.

Upon determining the particular mobile unit selected for response, dispatcher 410 may command dispatch software 426 via user interface 420 to transmit a message including data representing the caller location to the selected mobile unit. Specifically, computer 414 outputs this message to transmitter 432 which, in one embodiment, is a device having communication characteristics that are similar to a cellular telephone. In such an embodiment, transmitter 432 transmits the message via a cellular telephone network 436 to the particular mobile unit 406A-Z. At substantially the same time, dispatcher 410 calls the particular mobile unit 406A-Z using communication device 412. Communication device 412 may be a standard police radio, a cellular telephone, or some similar wireless communication device. This voice communication is transmitted over network 438 which may be the same as network 436 or a separate, cellular telephone type network. The voice communication is then relayed via network 438 to the particular mobile unit 406A-Z.

Referring now to FIG. 26, both the location message and the voice communication are received at mobile unit 406A-Z via receiver 452. Receiver 452 provides the location message to location interface software 450 of computer 14. Location interface software 450 decodes the location information for use by mobile software 12. Mobile software 12 causes processor 16 to access geographic data 28 in database 26 and perform a search for the caller location 408 in a manner similar to that described above. The caller location 408, once identified in geographic data 28, is automatically associated with the corresponding geographic data. User 24 is then automatically presented with a map 30 on display 20 including an icon representing caller location 408. Software 12 could also be configured to cause processor 16 to generate an auxiliary indication (not shown) on display 20 (or using some other audible or visual indicia) to alert user 24 that a new event has been reported to mobile unit 406.

Mobile software 12 executes an interface routine that periodically accesses a file maintained by location interface software 450 containing information derived from the messages from base unit 402. By periodically accessing this file (e.g., several times per second), mobile software 12 obtains new information relating to newly reported event.

The voice communication received by receiver 452 is answered by user 24. Through this voice link, dispatcher 410 can inform user 24 of the nature of the event and provide any other relevant information. Additionally, user 24 can inform dispatcher 410 that user 24 is able to respond to the event. Dispatcher 410 may then update the status of user 24 on display 422 to indicate that user 24 is en route to caller location 408.

As should be understood from the foregoing, in this application of the present invention, user 24 is instantly provided with a map 30 of the geographic area including caller location 408. Accordingly, user 24 may manipulate map 30 using any of the various map control tools described above to pan, zoom in, zoom out, etc. Moreover, user 24 may enable the aerial image feature of software 12 to view topographical features of caller location 408 and the surrounding area. Additionally, user 24 may access any information associated with the caller location 408 or any other relevant items such as nearby structures, etc. Such enhanced situational awareness may provide added safety to user 24 in responding to the event, and any other parties involved in or nearby the event.

It should also be understood from the foregoing that user 24 may create a data indicium at caller location 408 and attach information associated with the event using the procedures outlined above. For example, if the event involved an accident, user 24 may attach user-defined notes describing the accident (as described above), a video file of the scene, a digital sketch of the scene, audio files of witness interviews, etc.

An alternate embodiment of the invention includes a central server (not shown) in communication with base unit 402 and mobile units 406A-Z via a wireless network. In this embodiment, geographic data 28 of database 26 is stored in a memory associated with the central server. Additionally, any data indicia created by users 24 (and any information associated with those data indicia) are stored in the central server memory. Such a system could be configured to permit any of the plurality of mobile units 406A-Z (and base unit 402) to access data indicia (and associated information) defined by users 24 of other mobile units 406A-Z. Alternatively, security measures could be incorporated into the system to restrict or prevent access to certain data indicia based on certain criteria (e.g., categories of mobile units 406A-Z, etc.).

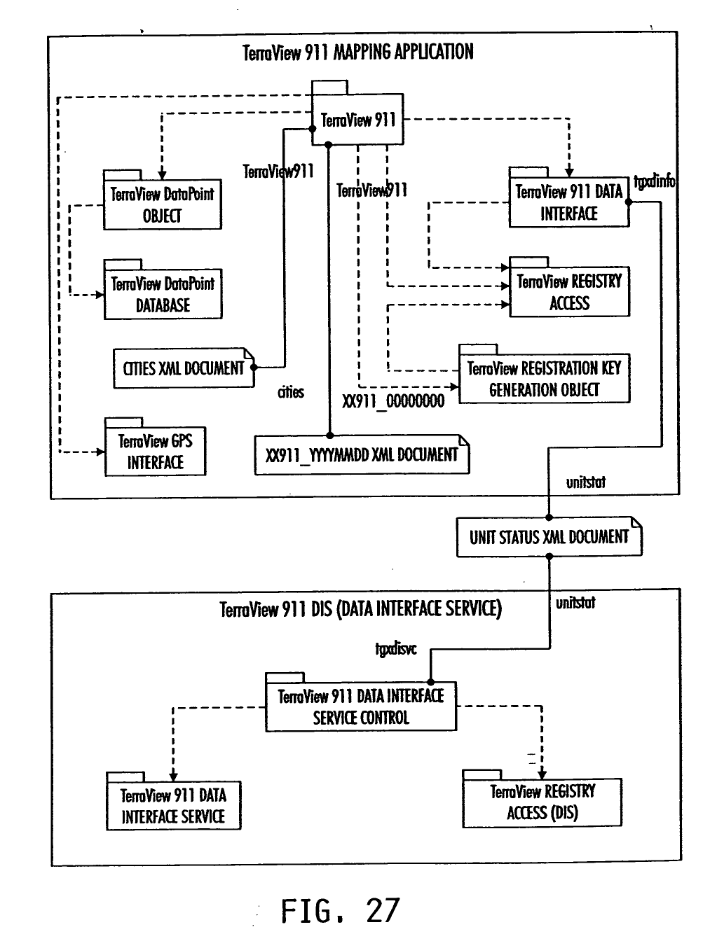

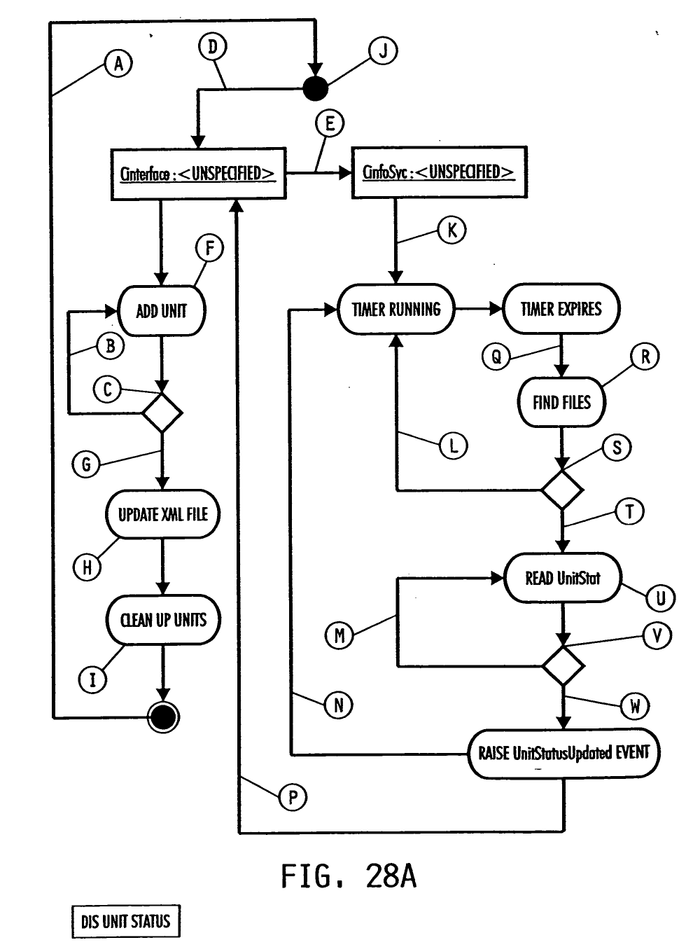

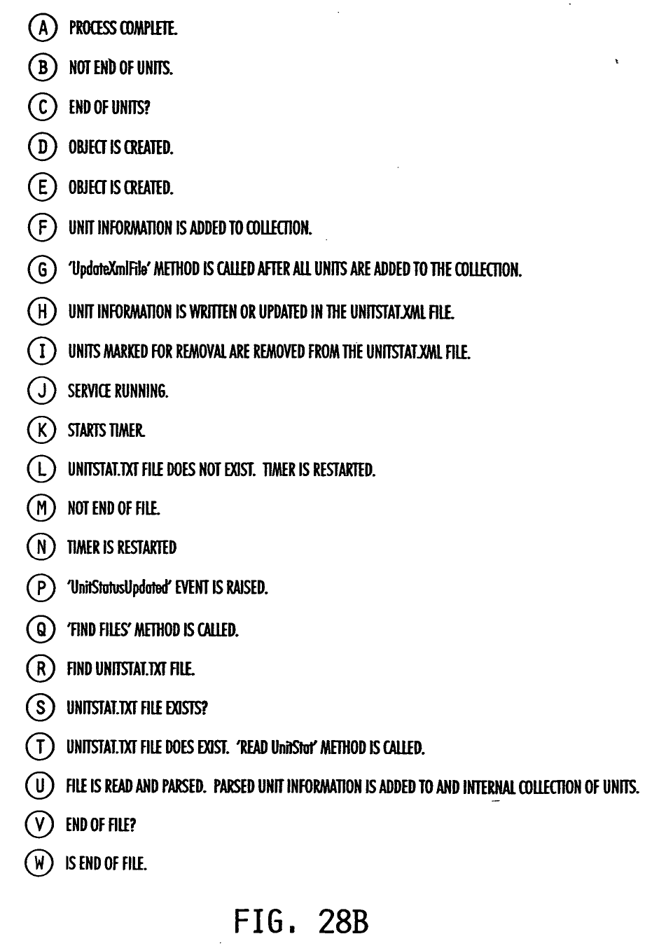

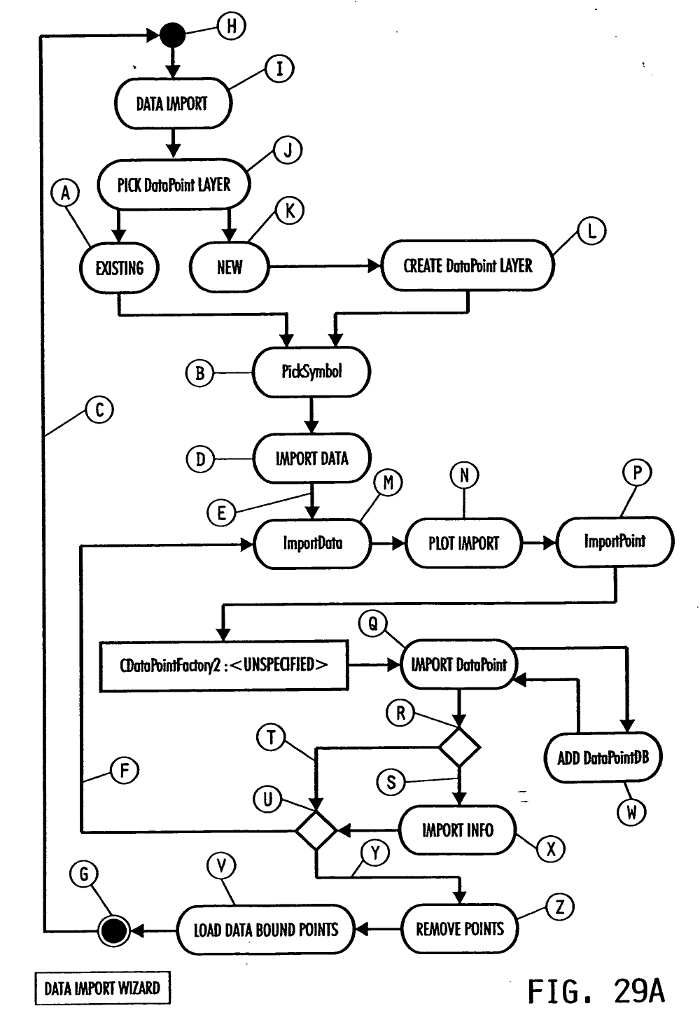

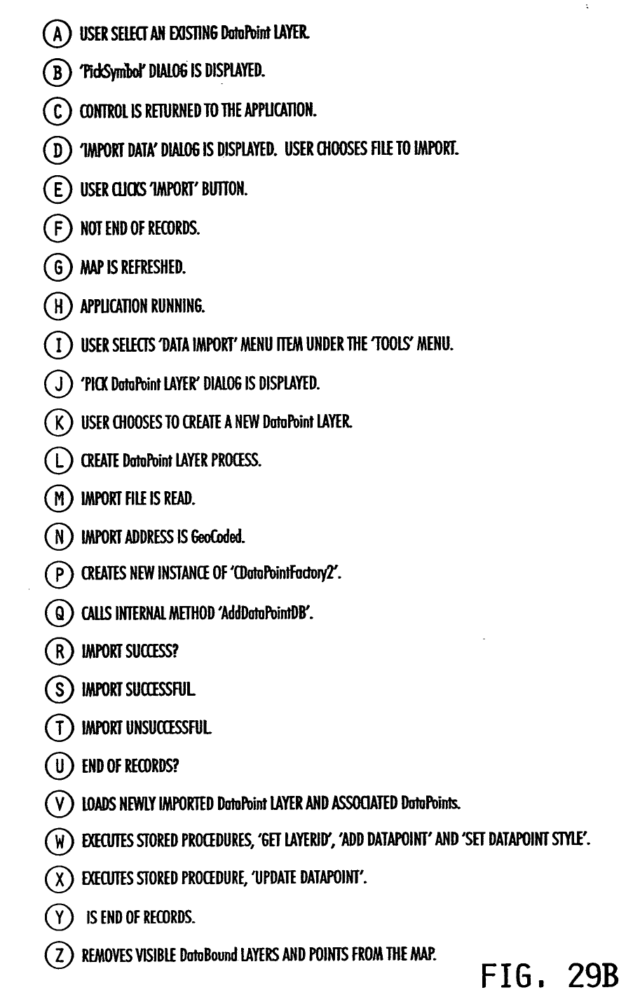

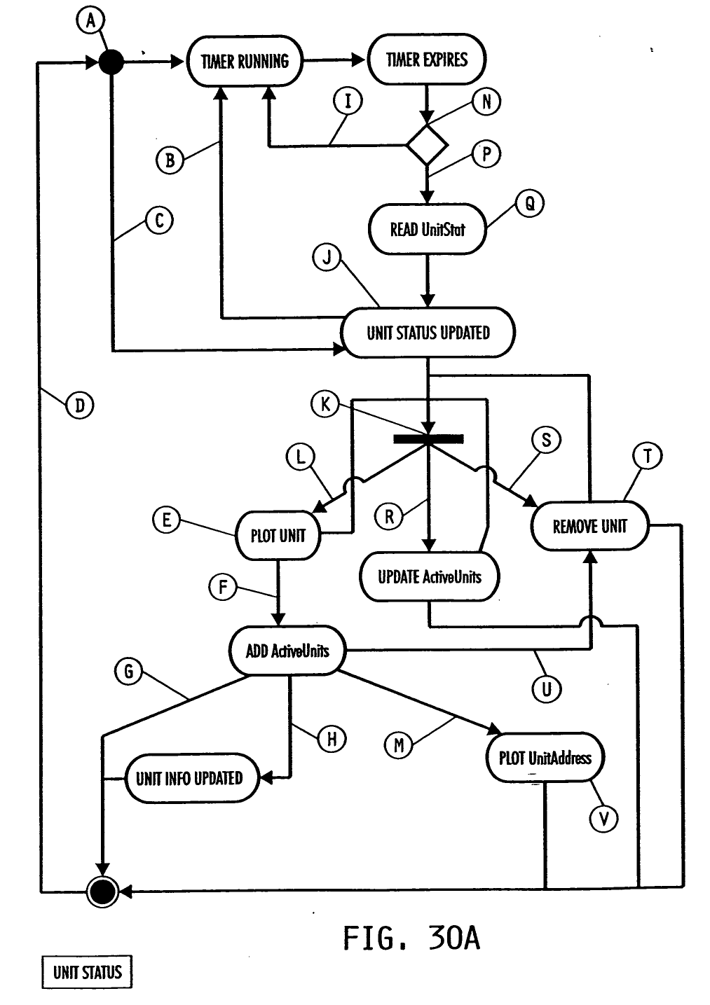

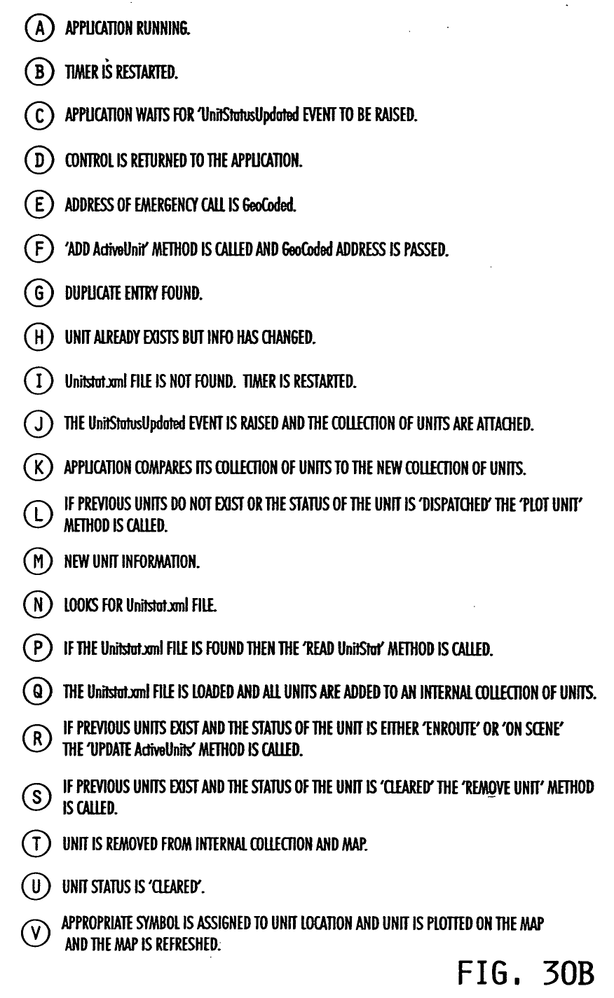

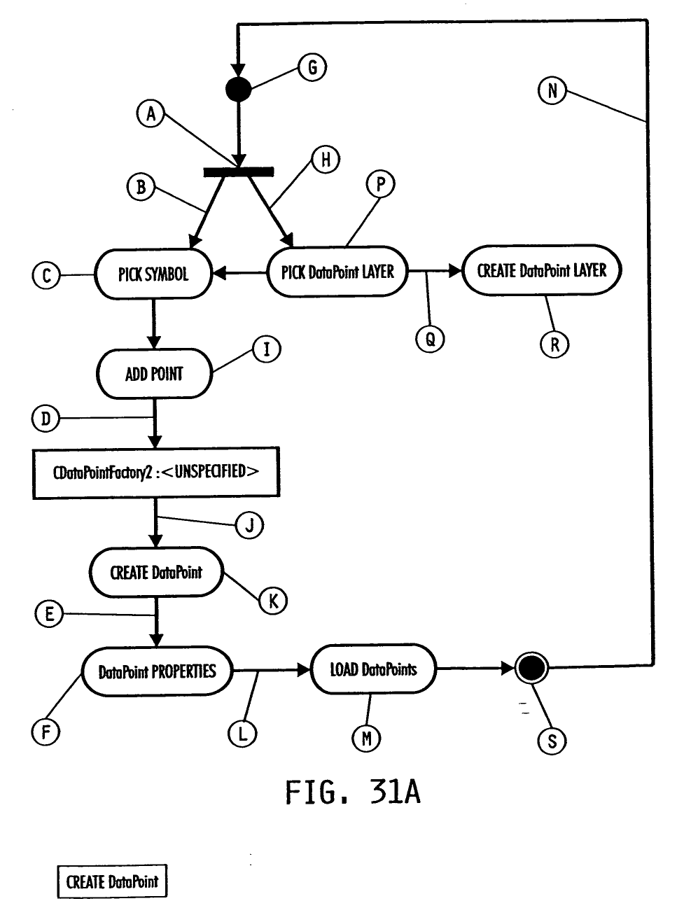

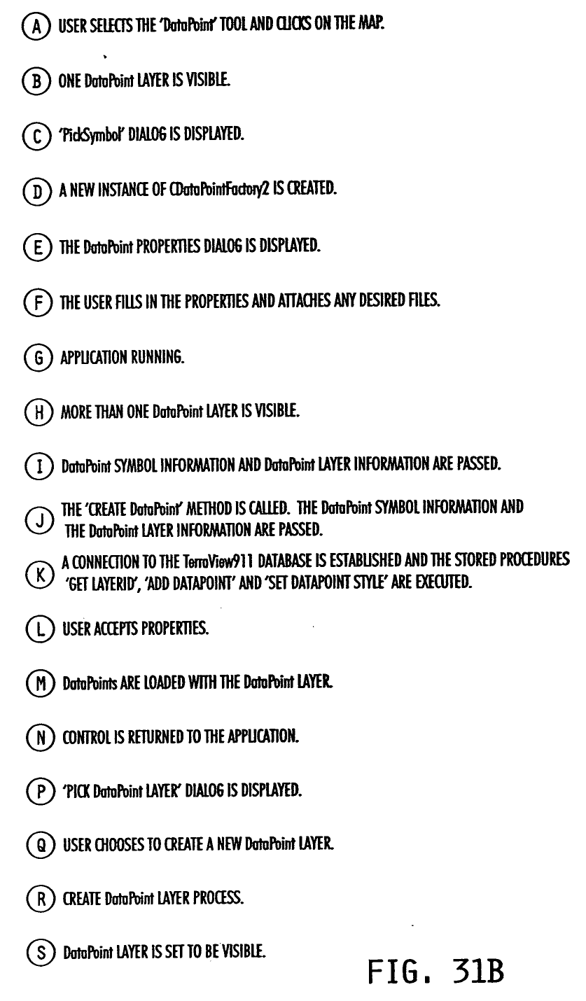

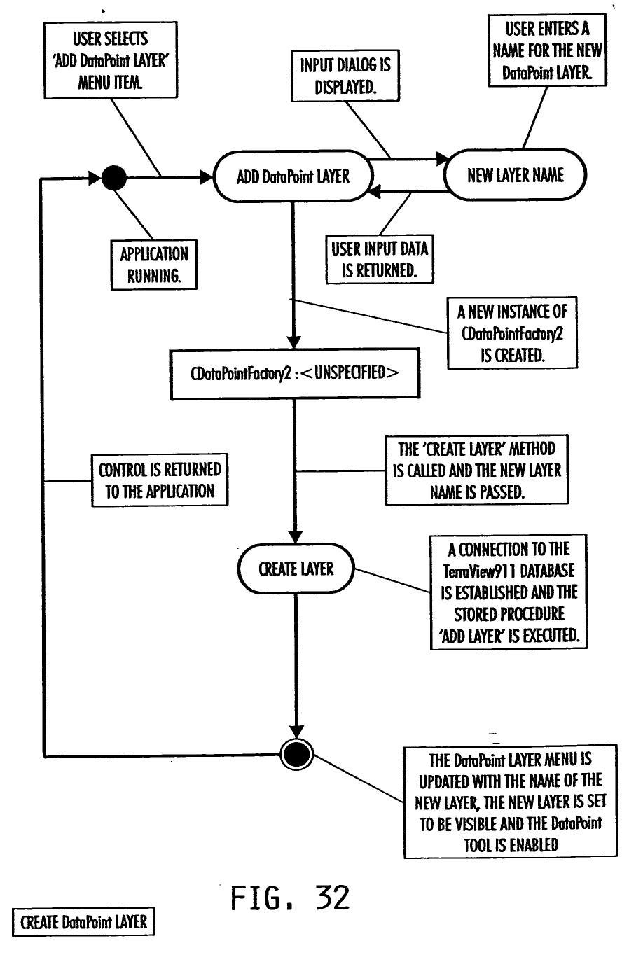

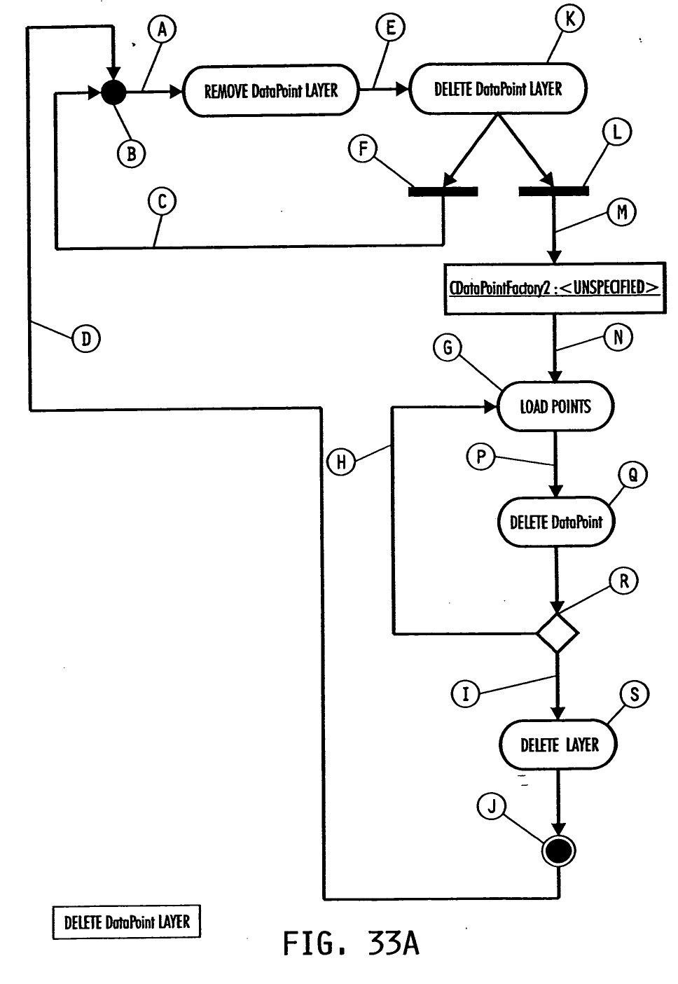

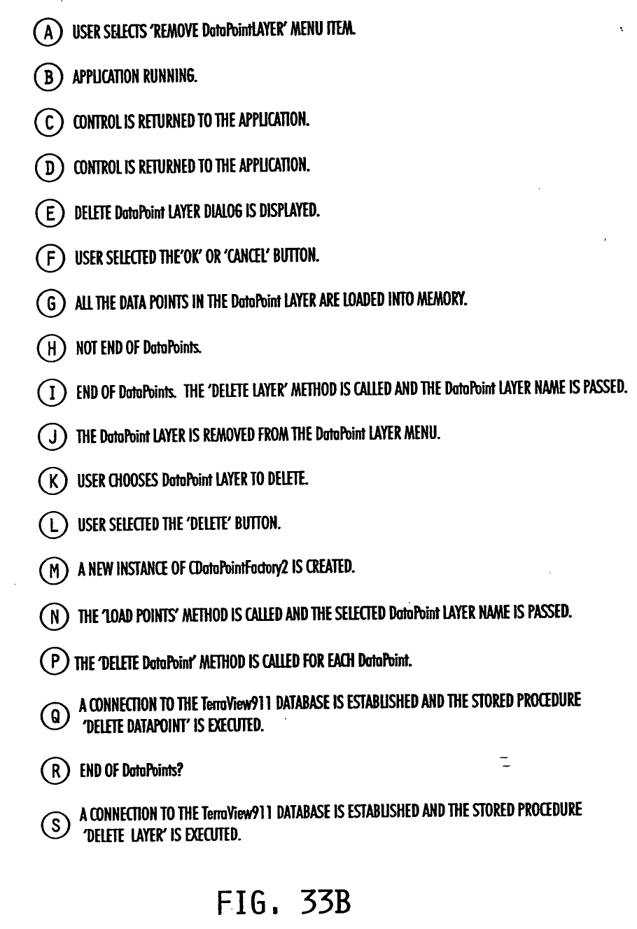

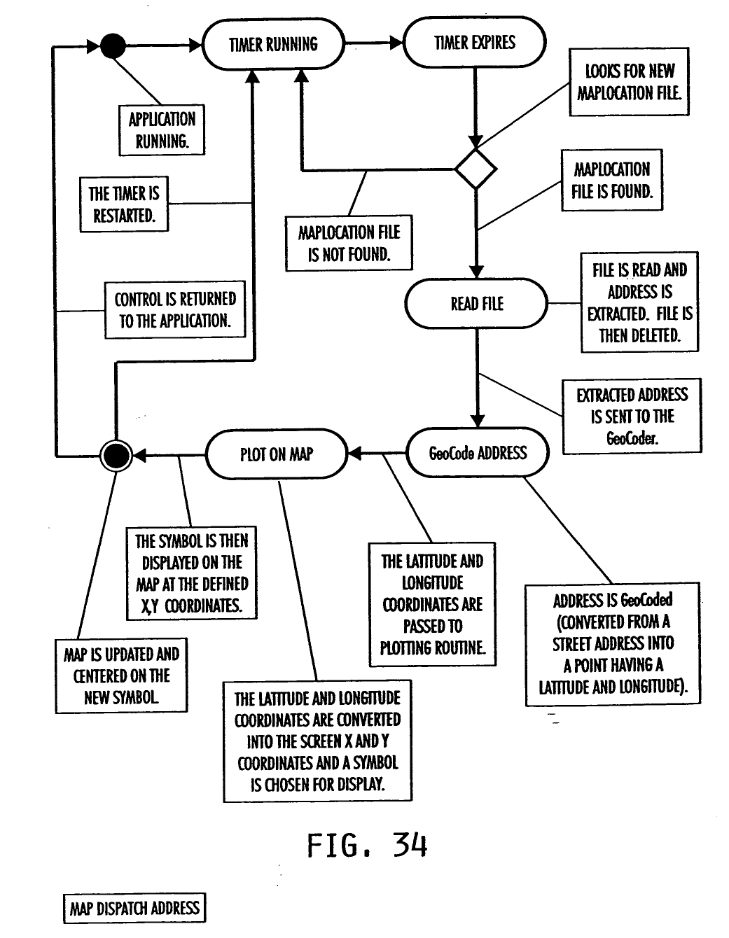

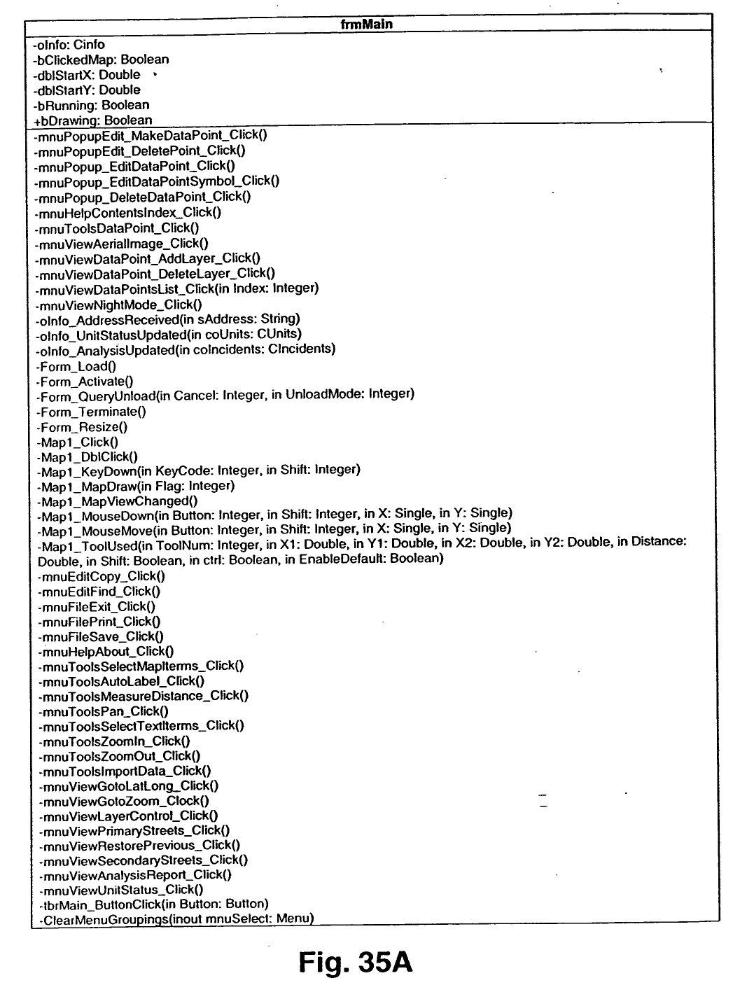

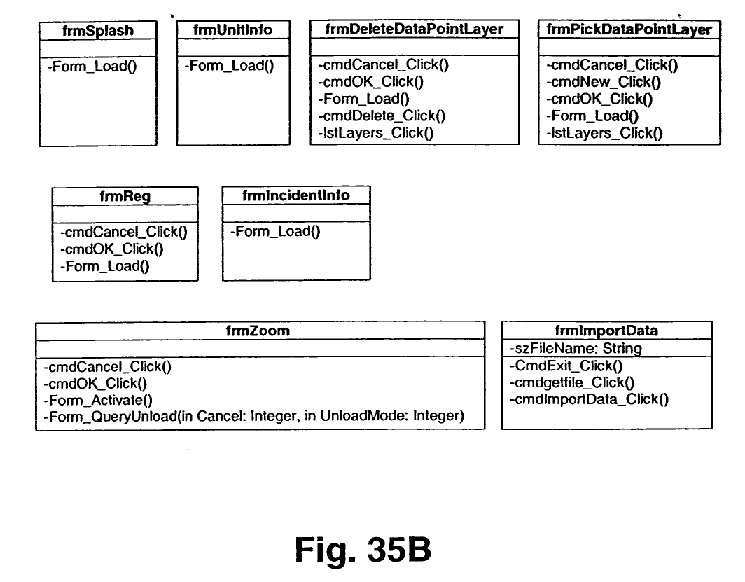

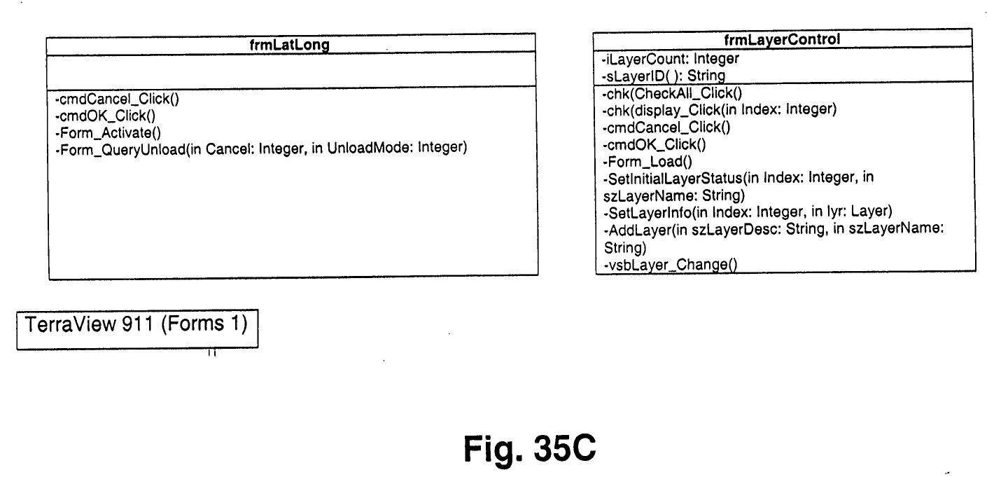

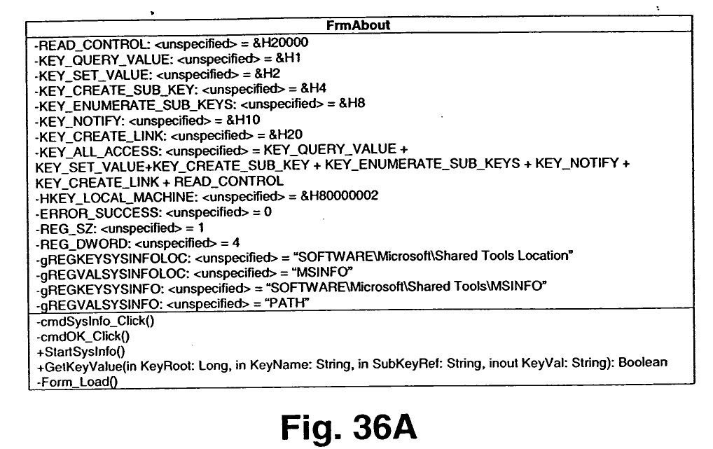

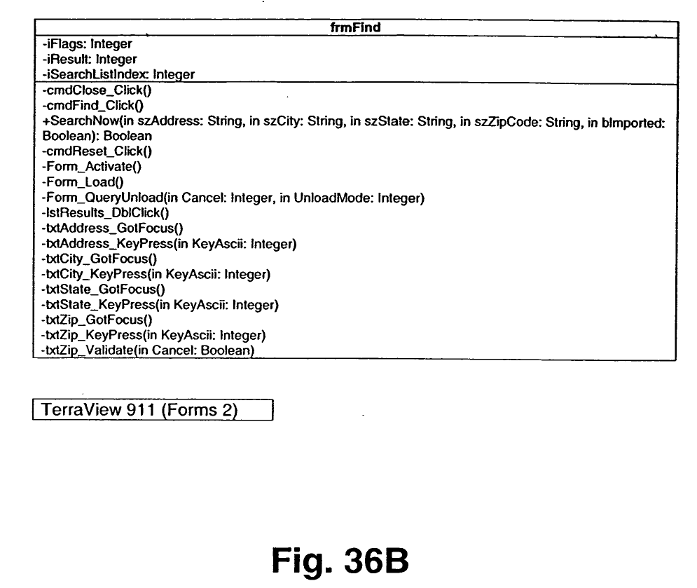

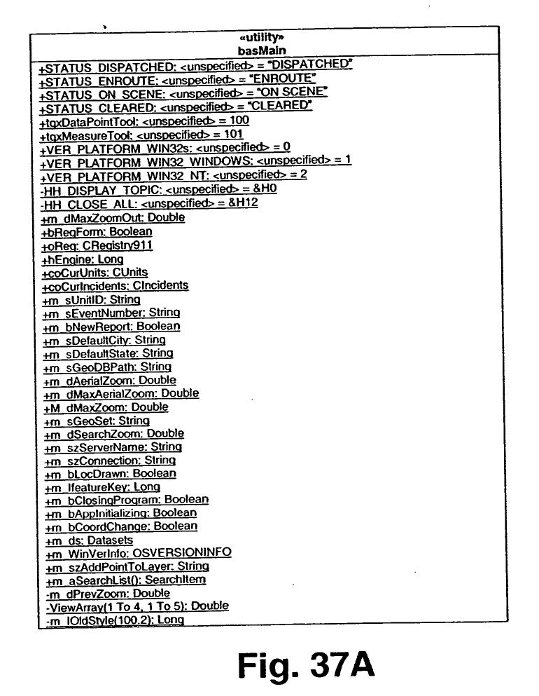

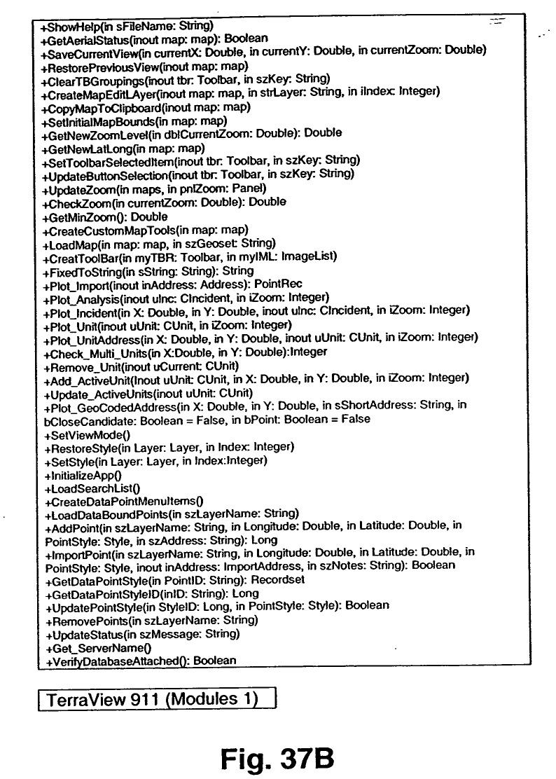

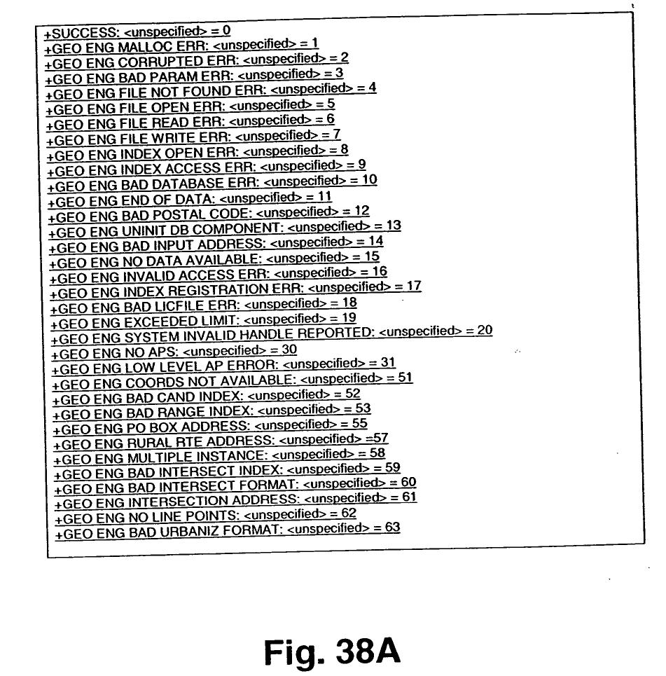

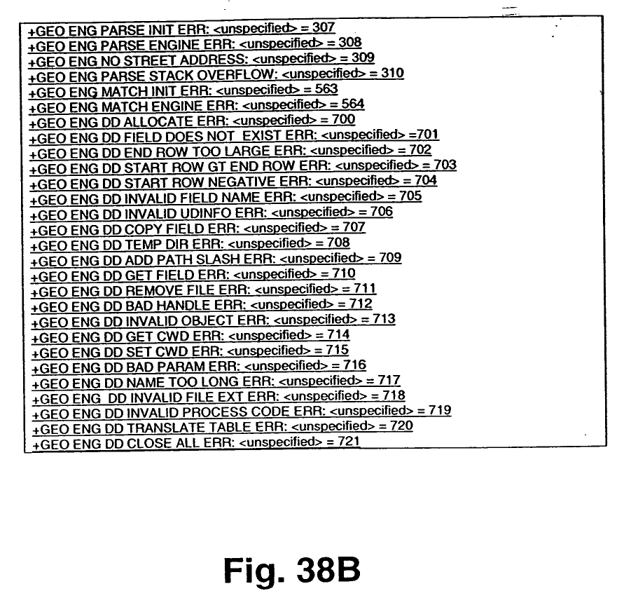

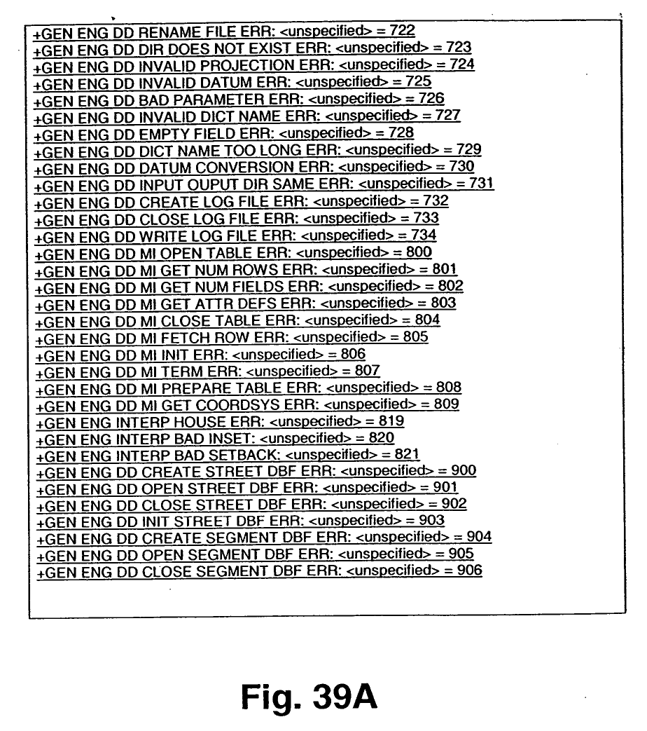

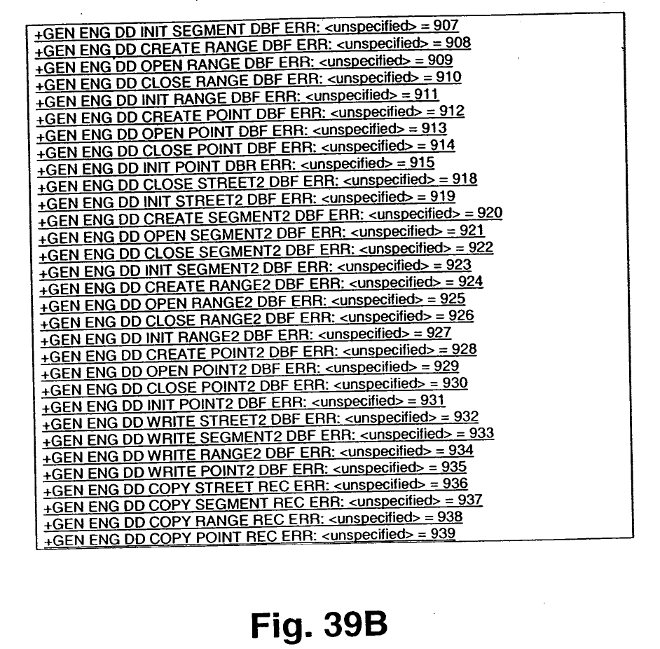

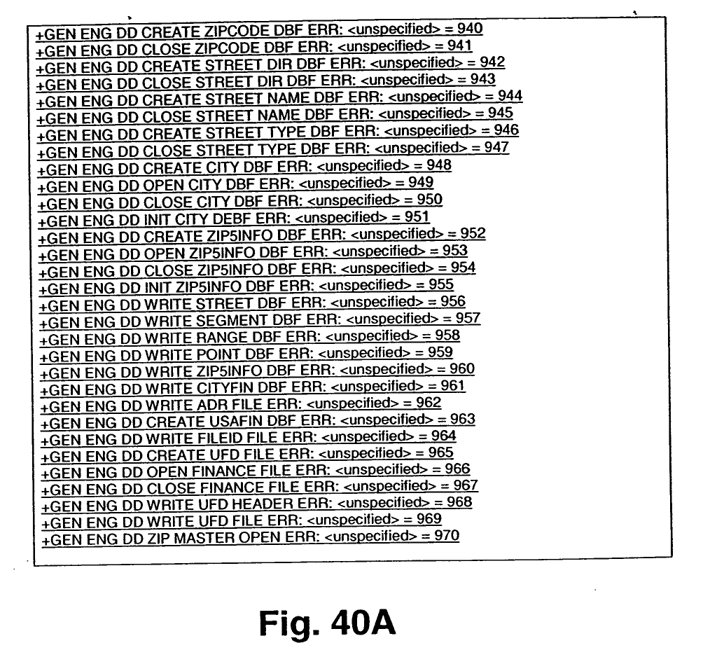

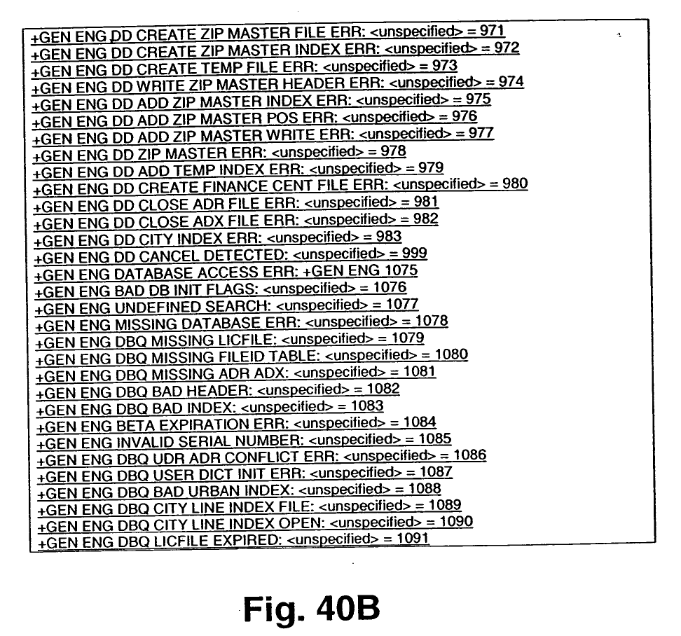

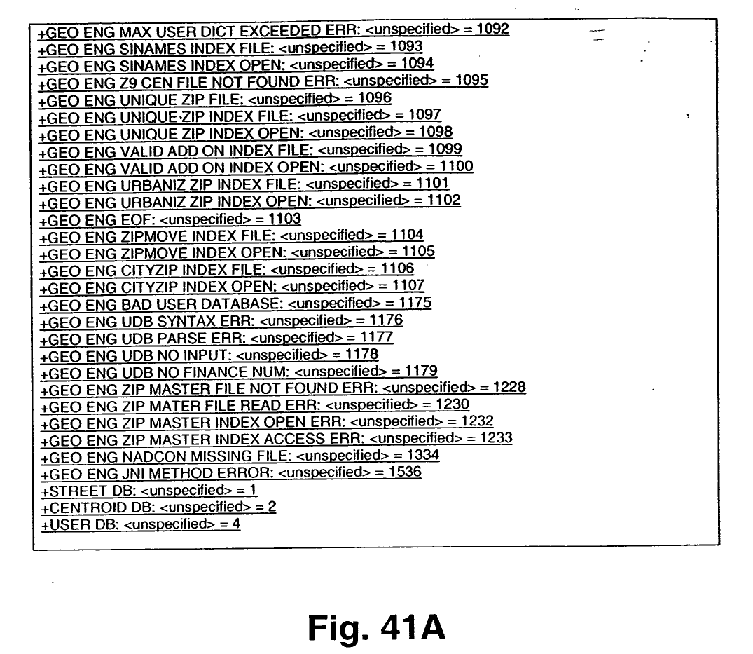

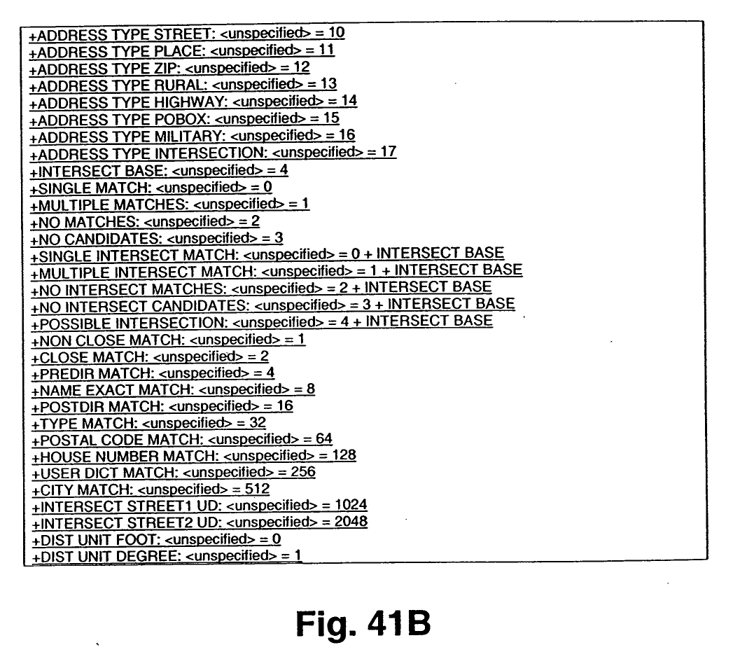

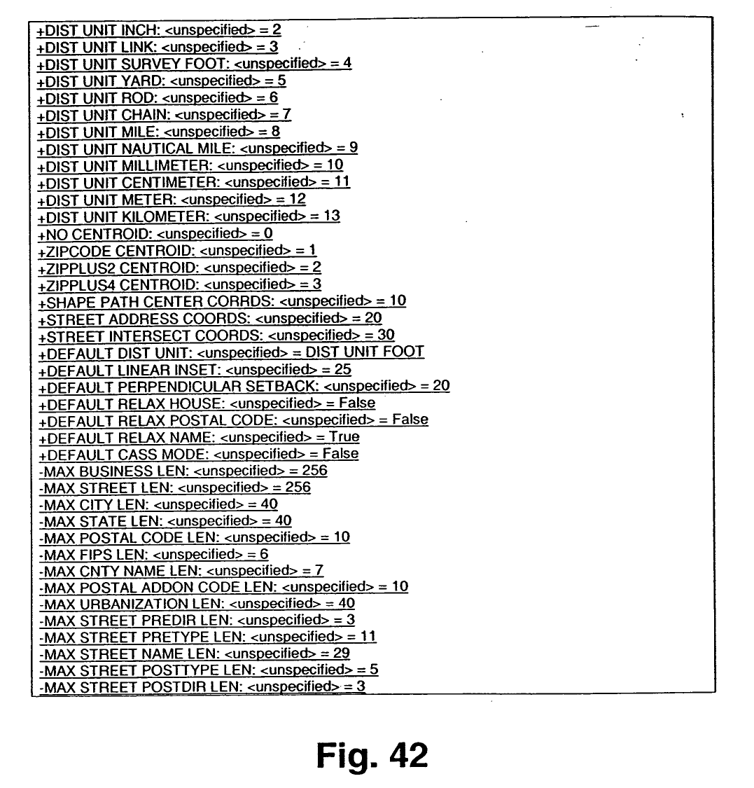

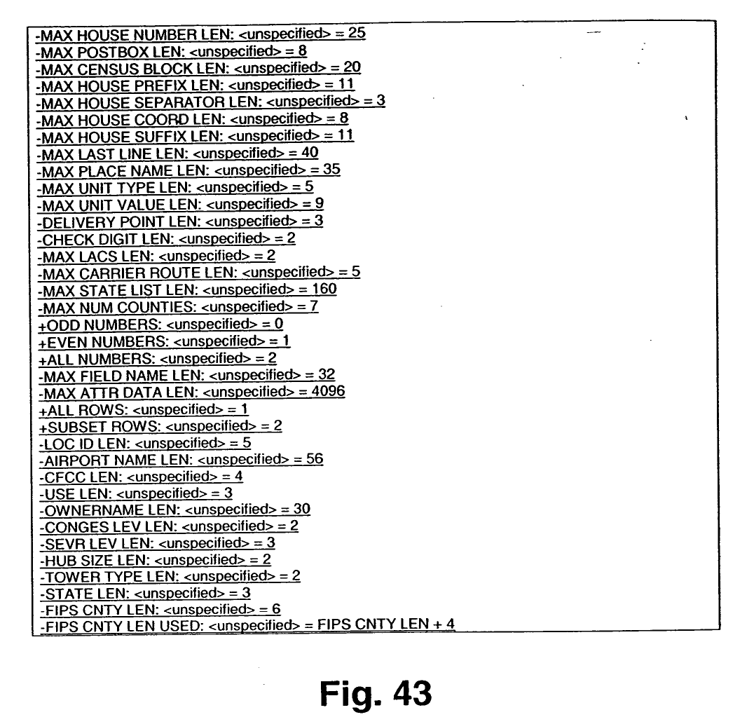

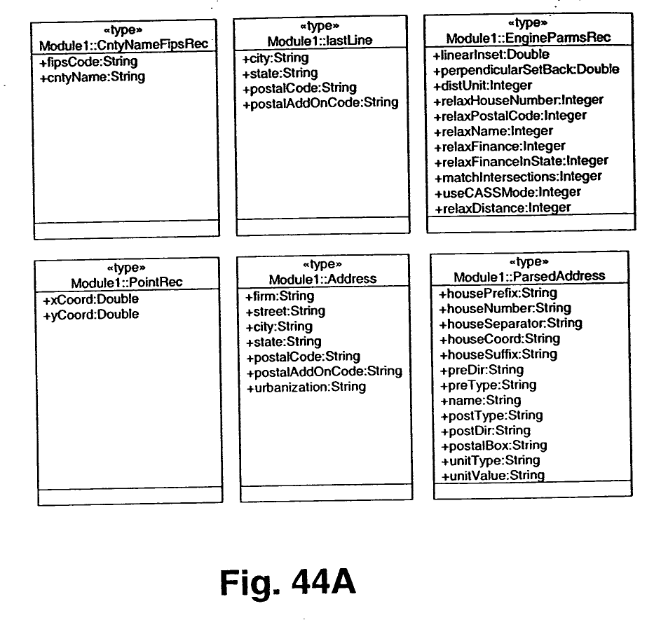

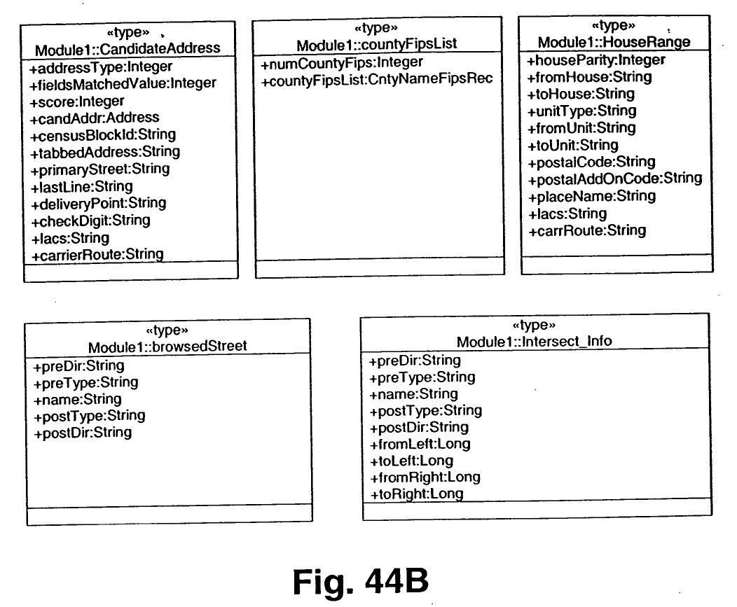

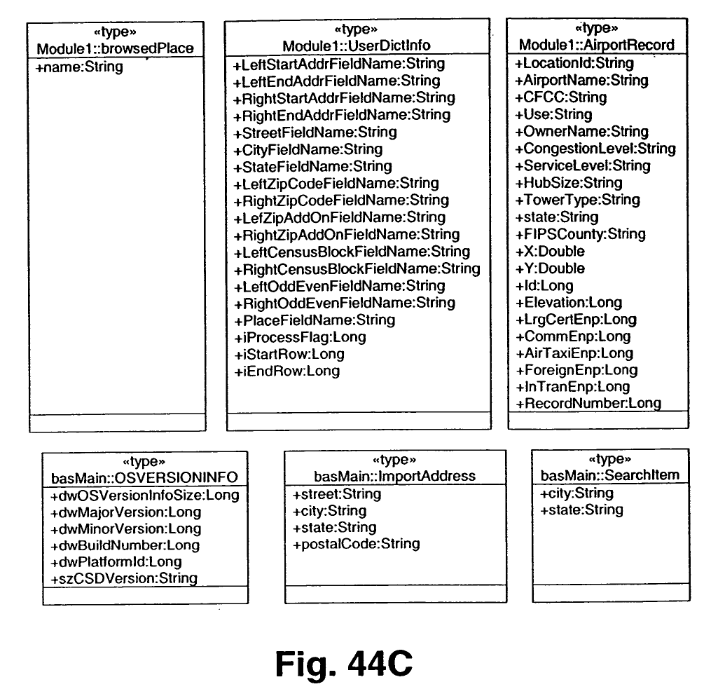

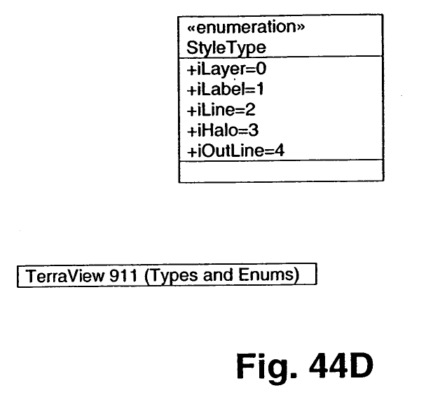

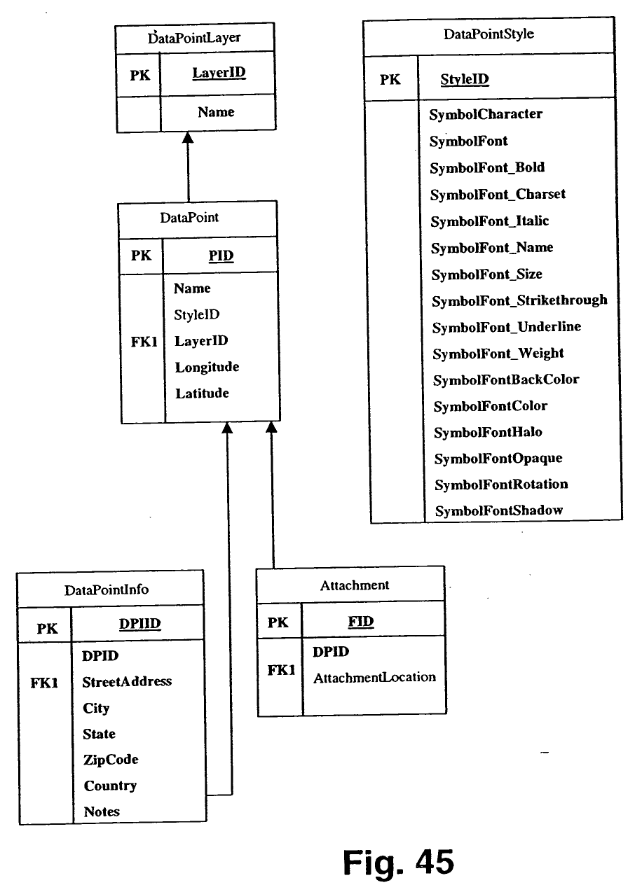

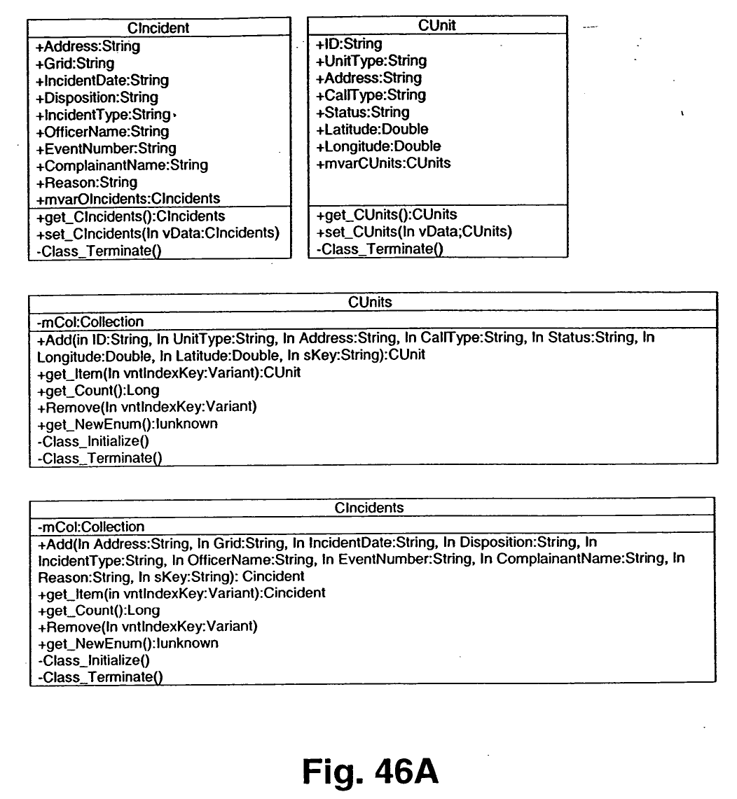

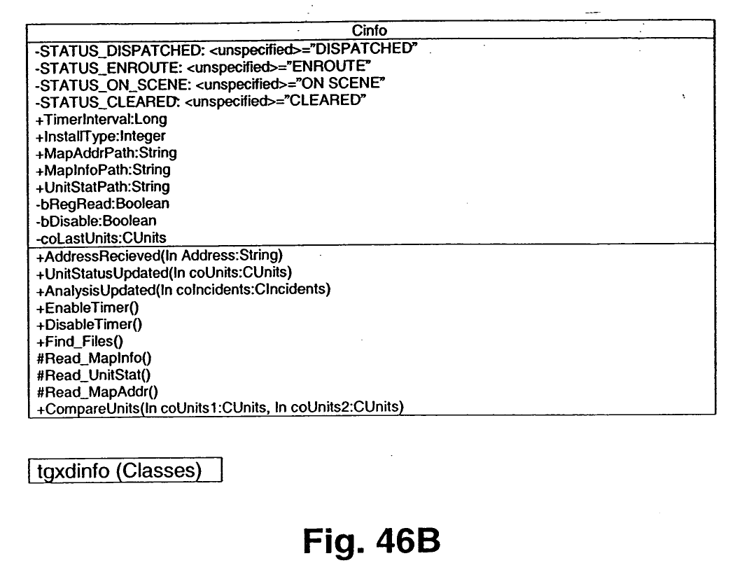

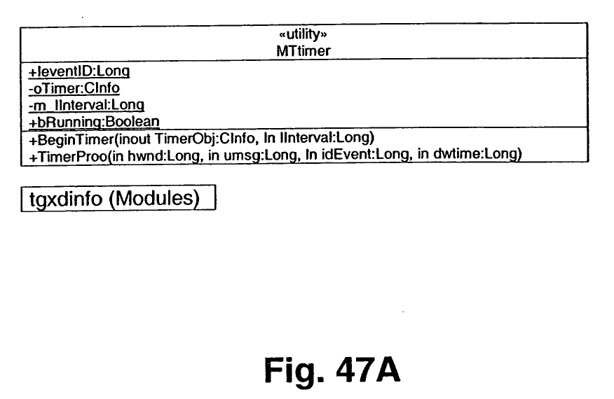

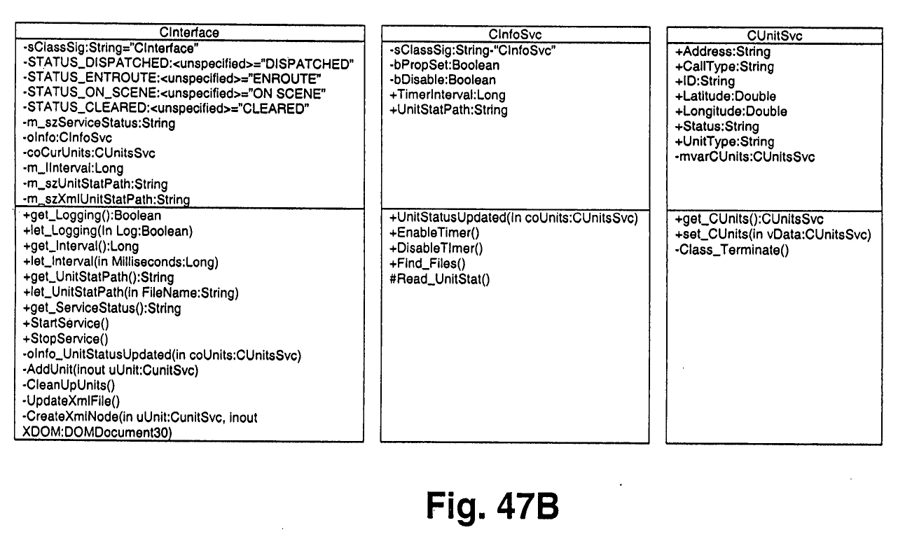

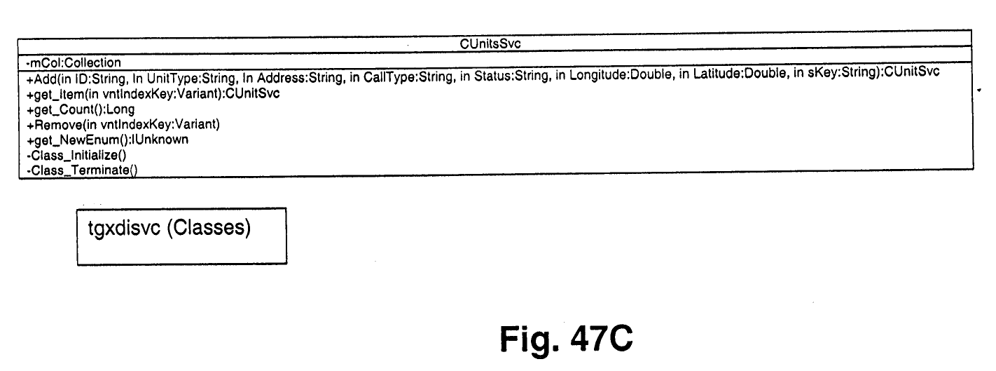

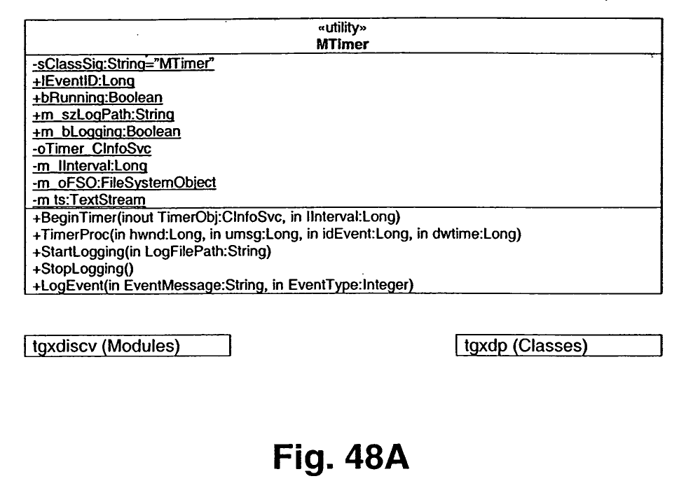

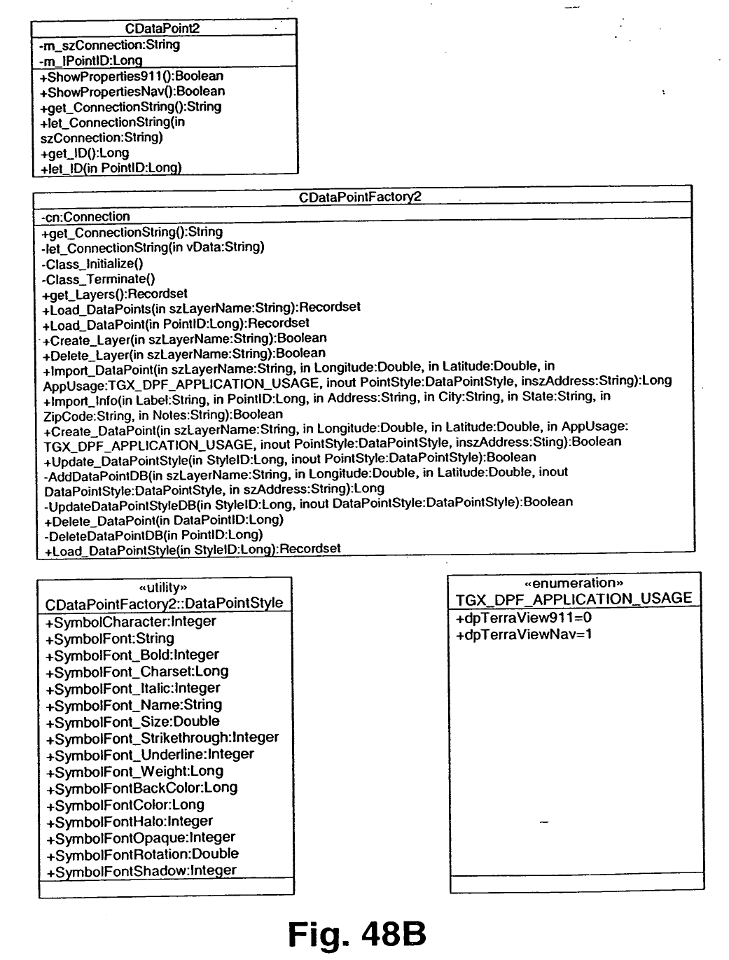

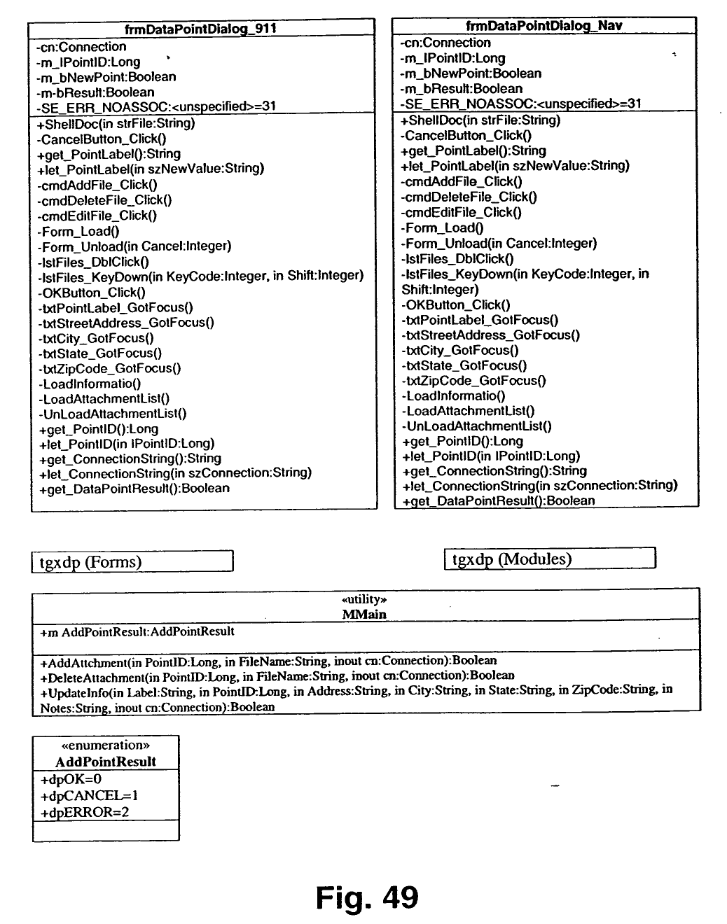

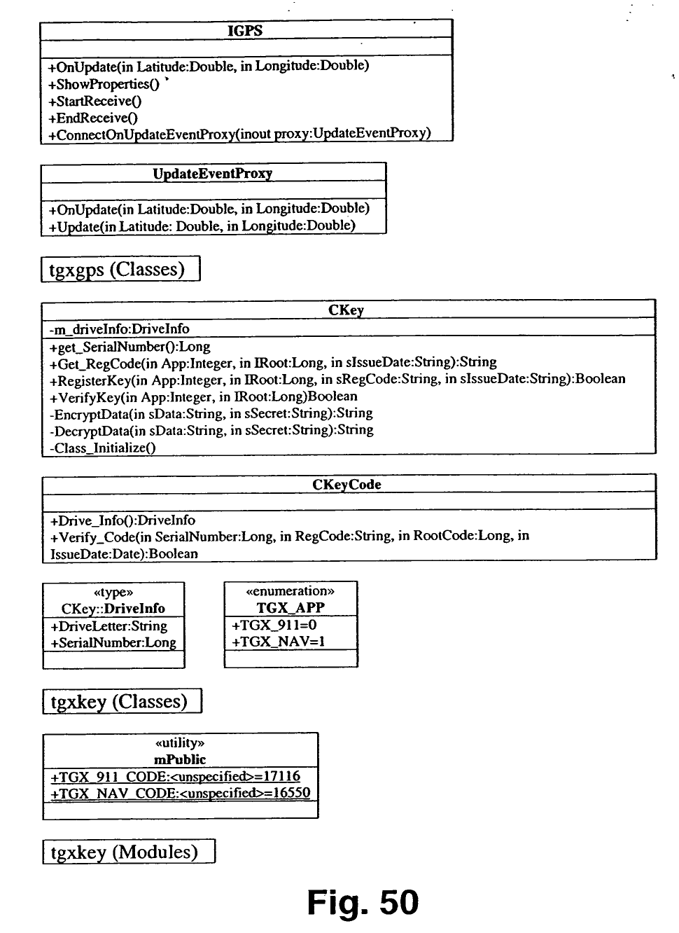

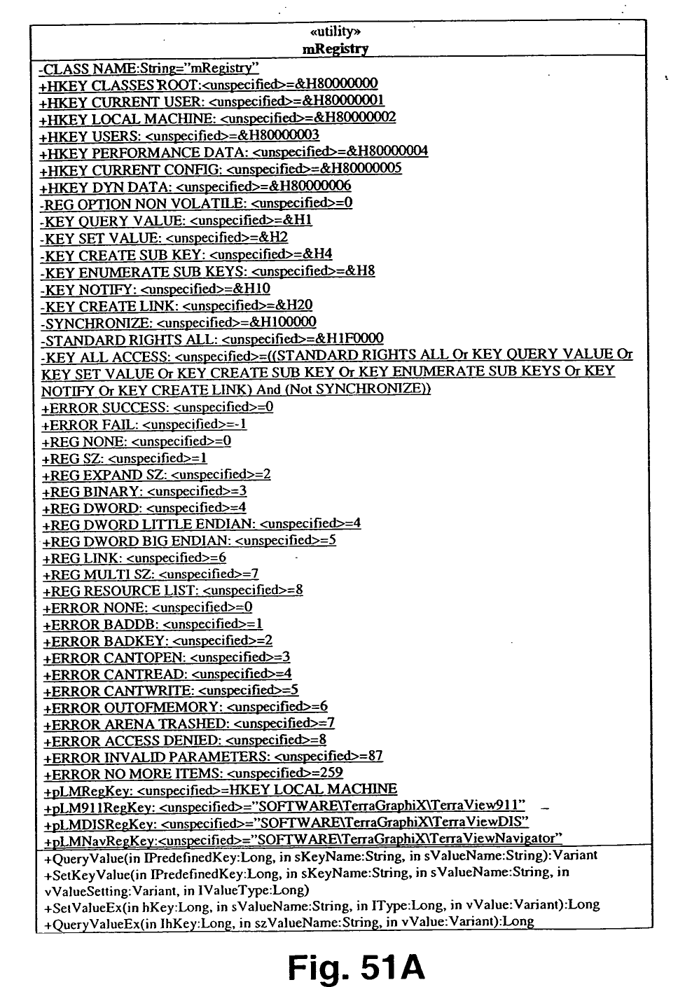

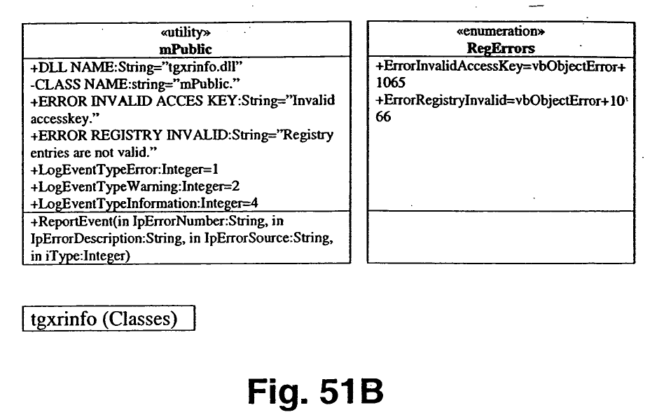

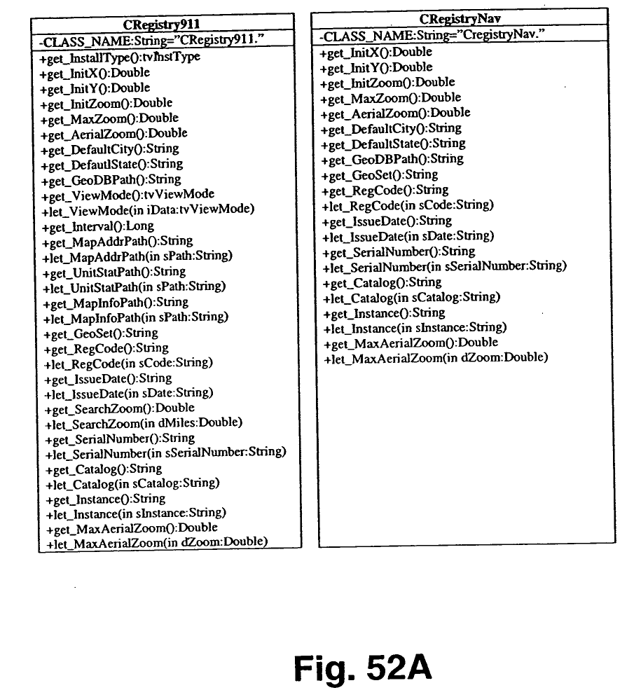

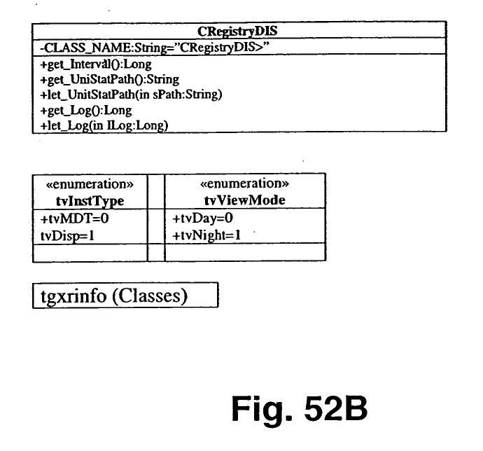

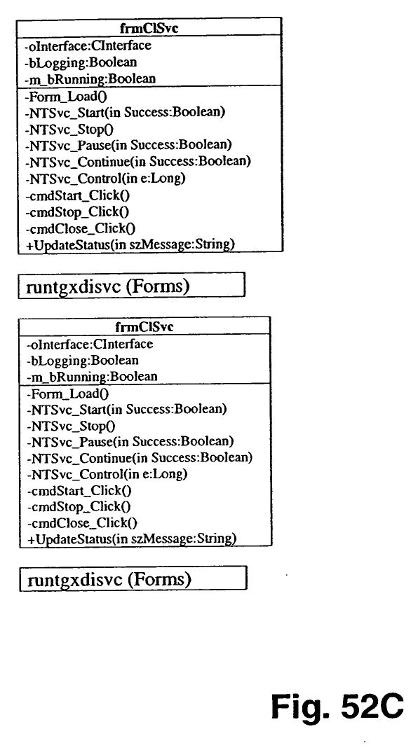

FIGS. 27-52 are provided to augment the preceding description of the present invention. FIGS. 27-52 include a plurality of process diagrams and diagrams depicting forms, modules, and classes including descriptions of properties, method definitions, parameters, and return types associated with the various form, module, and class diagrams.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

1. A system for associating information with a map feature, including:
a computer having a display, a memory, and a user interface for receiving user inputs;
a database including geographic data stored in the memory;
application software configured to respond to a user input by causing the computer to access the database and generate a map on the display corresponding to selected geographic data, the application software including a selection tool to enable the user to select a feature on the map and associate information with the feature.

2. The system of claim 1, wherein the associated information is accessible by activating the feature.

3. The system of claim 1, wherein the feature is a geographic location.

4. The system of claim 1, wherein the feature is a geographic area.

5. The system of claim 1, wherein the information is stored in the memory.

6. The system of claim 1, wherein the information includes user-defined notes relating to the feature, the notes being inputted by the user via the user interface into a notes field generated by the selection tool.

7. The system of claim 1, wherein the application software includes a copy map tool that generates a file including a copy of the map for storage in the memory.

8. The system of claim 1, wherein the application software includes a print map tool that generates a print file including data corresponding to the map for output to a printer.

9. The system of claim 1, wherein the selection tool enables the user to create an indicium for display in association with the feature, the associated information being accessible upon activation of the indicium.

10. The system of claim 9, wherein the indicium is an icon.

11. The system of claim 10, wherein the application software causes the computer to present the user with a selection of icon symbols on the display upon selection of the feature using the selection tool.

12. The system of claim 10, wherein the application software causes the computer to present the user with a selection of icon colors on the display upon selection of the feature using the selection tool.

13. The system of claim 1, wherein the information includes one of a label, an address, and a latitude/longitude designation.

14. The system of claim 13, wherein the information is provided by the user via the user interface into a dialog box generated by the selection tool.

15. The system of claim 1, wherein the information includes a file stored in the computer memory.

16. The system of claim 15, wherein the file includes one of text, a graphic representation, audio, and video.

17. The system of claim 15, wherein the file includes a diagram of a structure.

18. The system of claim 1, wherein the selection tool enables the user to define a plurality of user-defined layers of information.

19. The system of claim 18, wherein the application software further includes a layer control tool to enable the user to select a user-defined layer from the plurality of user-defined layers for display on the map.

20. The system of claim 19, wherein the map includes a plurality of map layers, each map layer including geographic data relating to a common map characteristic, the layer control tool enabling the user to select a map layer from the plurality of map layers for display on the map.

21 through 65 (cancelled.)
